(19) United States
(12) Patent Application Publication
(10) Pub. No.: US 2026/0254696 A1
(43) Pub. Date: Aug. 27, 2026

(54) REFERENCE SIGNAL TRANSMISSION METHOD AND APPARATUS

(71) Applicant: HUAWEI TECHNOLOGIES CO., LTD., Shenzhen (CN)

(72) Inventors: Xiaoyan Bi, Shanghai (CN); Chenglong Jiang, Shanghai (CN)

(21) Appl. No.: 19/654,678

(22) Filed: Apr. 22, 2026

Related U.S. Application Data
(63) Continuation of application No. PCT/CN2023/126600, filed on Oct. 25, 2023.

(51) Int. Cl. H04L 27/26; H04W 72/0453

(52) U.S. Cl. CPC H04L 27/261; H04W 72/0453

(57) ABSTRACT

A reference signal transmission method and an apparatus are provided and relate to the field of communication technologies, so that accuracy of channel estimation can be improved while a quantity of antenna ports is increased. The method includes: determining, based on a frequency-domain channel matrix associated with an antenna port and a frequency-domain sampling number of a reference signal associated with the antenna port, a frequency-domain resource mapping relationship for the reference signal; sending first information to a receiver device, where the first information indicates the frequency-domain resource mapping relationship for the reference signal; and sending or receiving the reference signal based on the frequency-domain resource mapping relationship for the reference signal.

### CROSS-REFERENCE TO RELATED APPLICATIONS

This application is a continuation of International Application No. PCT/CN2023/126600, filed on Oct. 25, 2023, the disclosure of which is hereby incorporated by reference in its entirety.

### TECHNICAL FIELD

Embodiments of this disclosure relate to the field of communication technologies, and in particular, to a reference signal transmission method and an apparatus.

### BACKGROUND

In communication systems, a network device may send reference signals to a terminal device through antenna ports, and the terminal device performs channel estimation based on the received reference signals.

A quantity of antenna ports may be increased to implement sparsification of time-frequency resources for reference signals and achieve a higher number of transmission streams, so as to improve communication performance.

To keep total overheads of reference signals unchanged, the increase of the quantity of antenna ports, time-frequency domain density of the antenna ports is accordingly reduced. The reduction is typically done by increasing a sampling interval. However, the increase of the sampling interval shrinks sampling bandwidth, causing a high proportion of aliasing energy, consequently affecting accuracy of channel estimation.

Therefore, how to improve accuracy of channel estimation while increasing a quantity of antenna ports becomes a technical problem to be urgently resolved.

### SUMMARY

This disclosure provides a reference signal transmission method and an apparatus, so that accuracy of channel estimation can be improved while a quantity of antenna ports is increased.

According to a first aspect, an embodiment provides a reference signal transmission method. The method may be performed by a transmitter device. Unless otherwise specified, the “transmitter device” may be a transmitter device itself, or may be a component (such as a processor, a chip, or a chip system) in a transmitter device, or may be a logic module or software that can implement all or some functions of a transmitter device. The method includes: determining, based on a frequency-domain channel matrix associated with an antenna port and a frequency-domain sampling number of a reference signal associated with the antenna port, a frequency-domain resource mapping relationship for the reference signal; sending first information to a receiver device, where the first information indicates the frequency-domain resource mapping relationship for the reference signal; and sending or receiving the reference signal based on the frequency-domain resource mapping relationship for the reference signal.

Based on the first aspect, the transmitter device may dynamically determine the frequency-domain resource mapping relationship for the reference signal based on the frequency-domain channel matrix associated with the antenna port and the frequency-domain sampling number of the reference signal associated with the antenna port, and dynamically switch the frequency-domain resource mapping relationship for the reference signal based on the first information, so that a better frequency-domain sampling position can be dynamically obtained while a quantity of antenna ports is increased, improving accuracy of channel estimation, and improving communication performance.

In some embodiments, a frequency-domain resource mapping relationship interval for the reference signal is determined based on the frequency-domain channel matrix and the frequency-domain sampling number of the reference signal; and the frequency-domain resource mapping relationship for the reference signal is determined based on the frequency-domain resource mapping relationship interval for the reference signal and the frequency-domain sampling number of the reference signal.

The transmitter device may first determine the frequency-domain resource mapping relationship interval for the reference signal, and then determine the frequency-domain resource mapping relationship for the reference signal in the interval, improving reliability of the determined frequency-domain resource mapping relationship.

In some embodiments, a rank of the frequency-domain channel matrix and a first value are determined based on the frequency-domain channel matrix, where the first value is a quantity of singular values that meet a first condition and that are in a singular value decomposition result of the frequency-domain channel matrix, and the first condition is that a difference between a reconstructed matrix corresponding to a singular value and the frequency-domain channel matrix is less than or equal to a first threshold; and the frequency-domain resource mapping relationship interval for the reference signal is determined based on the rank of the frequency-domain channel matrix, the first value, and the frequency-domain sampling number of the reference signal.

In some embodiments, in response to the frequency-domain sampling number of the reference signal being less than or equal to the first value, the frequency-domain resource mapping relationship interval for the reference signal is a first frequency-domain resource mapping relationship interval; or in response to the frequency-domain sampling number of the reference signal being greater than the first value and being less than or equal to the rank of the frequency-domain channel matrix, the frequency-domain resource mapping relationship interval for the reference signal is a second frequency-domain resource mapping relationship interval; or in response to the frequency-domain sampling number of the reference signal being greater than the rank of the frequency-domain channel matrix, the frequency-domain resource mapping relationship interval for the reference signal is a third frequency-domain resource mapping relationship interval.

Based on the foregoing embodiments, the transmitter device may divide the frequency-domain resource mapping relationship interval based on the rank of the frequency-domain channel matrix, the first value, and the frequency-domain sampling number of the reference signal, and then may select an appropriate frequency-domain resource mapping relationship indication manner for each frequency-domain resource mapping relationship interval, improving reliability of the frequency-domain resource mapping relationship.

In some embodiments, first indication information is sent to the receiver device, where the first indication information indicates the frequency-domain resource mapping relationship interval for the reference signal.

The transmitter device may explicitly indicate the frequency-domain resource mapping relationship interval for the reference signal by using the first indication information.

In some embodiments, the first indication information includes the rank of the frequency-domain channel matrix, the first value, and the frequency-domain sampling number of the reference signal, where the first value is a quantity of singular values that meet the first condition and that are in a singular value decomposition result of the frequency-domain channel matrix, and the first condition is that a difference between a reconstructed matrix corresponding to a singular value and the frequency-domain channel matrix is less than or equal to the first threshold; or the first indication information includes an interval index of the frequency-domain resource mapping relationship interval for the reference signal; or the first indication information includes interval frequency-domain range information of the frequency-domain resource mapping relationship interval for the reference signal; or the first indication information includes interval position information of the frequency-domain resource mapping relationship interval for the reference signal.

A plurality of feasible solutions are provided for design of the first indication information.

In some embodiments, singular value decomposition is performed on the frequency-domain channel matrix, to obtain a singular value decomposition result; and the frequency-domain sampling number of the reference signal is determined based on the singular value decomposition result.

In some embodiments, a pseudo-random sequence is determined based on a random number seed; a subcarrier associated with each of one or more frequency-domain resources associated with the reference signal is determined based on the pseudo-random sequence and the frequency-domain sampling number of the reference signal; and the frequency-domain resource mapping relationship is determined based on a position that is of a subcarrier associated with the reference signal and that is in the frequency-domain resource mapping relationship interval for the reference signal.

The transmitter device may determine the frequency-domain resource mapping relationship based on the random number seed and the frequency-domain sampling number of the reference signal, providing a feasible solution for determining the frequency-domain resource mapping relationship.

In some embodiments, the first information includes the random number seed.

In some embodiments, the first information further includes the frequency-domain sampling number of the reference signal.

Based on the foregoing embodiments, the transmitter device may send the random number seed (and the frequency-domain sampling number of the reference signal) to the receiver device based on the first information, so that signaling overheads can be reduced while the receiver device can determine the frequency-domain resource mapping relationship based on the random number seed and the frequency-domain sampling number of the reference signal.

In some embodiments, the first information further indicates that the frequency-domain resource mapping relationship interval for the reference signal is the third frequency-domain resource mapping relationship interval.

The third frequency-domain resource mapping relationship interval may be a region that has high frequency-domain density (for example, a large frequency-domain sampling number) and that is less sensitive to a resource position for the reference signal. For all frequency-domain resource mapping relationship intervals that have this characteristic (including but not limited to the third frequency-domain resource mapping relationship interval), the random number seed and the frequency-domain sampling number of the reference signal can be used to indicate the frequency-domain resource mapping relationship, to improve reliability of the frequency-domain resource mapping relationship.

In some embodiments, singular value decomposition is performed on the frequency-domain channel matrix, to obtain a singular value decomposition result; a projection matrix is determined based on the singular value decomposition result, where a row number of the projection matrix is equal to a quantity of frequency-domain resources associated with the reference signal, and a column number of the projection matrix is equal to a quantity of frequency-domain subcarriers; a frequency-domain sampling sequence is determined based on the projection matrix; and the frequency-domain resource mapping relationship for the reference signal is determined based on the frequency-domain sampling sequence.

The transmitter device may determine the frequency-domain resource mapping relationship based on the frequency-domain sampling sequence, providing a feasible solution for determining the frequency-domain resource mapping relationship.

In some embodiments, a frequency-domain sampling sequence index corresponding to the frequency-domain sampling sequence is determined based on the frequency-domain sampling sequence.

In some embodiments, the first information includes the frequency-domain sampling sequence index.

The transmitter device may send the frequency-domain sampling sequence index to the receiver device based on the first information, so that signaling overheads can be reduced while the receiver device can determine the frequency-domain resource mapping relationship based on the frequency-domain sampling sequence index.

In some embodiments, the first information further indicates that a frequency-domain resource mapping relationship interval for the reference signal is the second frequency-domain resource mapping relationship interval.

The second frequency-domain resource mapping relationship interval may be a region in which the frequency-domain sampling number is equivalent to the rank of the frequency-domain channel matrix or the first value. For all frequency-domain resource mapping relationship intervals that have this characteristic (including but not limited to the second frequency-domain resource mapping relationship interval), the frequency-domain sampling sequence index can be used to indicate the frequency-domain resource mapping relationship, to improve reliability of the frequency-domain resource mapping relationship.

In some embodiments, a preset correspondence is sent to the receiver device, where the preset correspondence indicates the frequency-domain sampling sequence index and the frequency-domain sampling sequence associated with the frequency-domain sampling sequence index.

The transmitter device sends the preset correspondence to the receiver device, so that the receiver device can determine, based on the preset correspondence, the frequency-domain sampling sequence associated with the frequency-domain sampling sequence index, and then determine the frequency-domain resource mapping relationship.

In some embodiments, singular value decomposition is performed on the frequency-domain channel matrix, to obtain a singular value decomposition result; a projection matrix is determined based on the singular value decomposition result, where a row number of the projection matrix is equal to a quantity of frequency-domain resources associated with the reference signal, and a column number of the projection matrix is equal to a quantity of frequency-domain subcarriers; and a bitmap is determined based on the projection matrix, where the bitmap indicates a subcarrier associated with each of one or more frequency-domain resources associated with the reference signal.

The transmitter device may determine the frequency-domain resource mapping relationship based on the bitmap, providing a feasible solution for determining the frequency-domain resource mapping relationship.

In some embodiments, the first information includes the bitmap.

The transmitter device may send the bitmap to the receiver device based on the first information, to improve reliability of the frequency-domain resource mapping relationship.

In some embodiments, the first information further indicates that a frequency-domain resource mapping relationship interval for the reference signal is the first frequency-domain resource mapping relationship interval.

The first frequency-domain resource mapping relationship interval may be a region that has extremely low frequency-domain density and that is very sensitive to a resource position for the reference signal. For all frequency-domain resource mapping relationship intervals that have this characteristic (including but not limited to the first frequency-domain resource mapping relationship interval), the bitmap can be used to indicate the frequency-domain resource mapping relationship, to improve reliability of the frequency-domain resource mapping relationship.

According to a second aspect, an embodiment provides a reference signal transmission method. The method may be performed by a receiver device. Unless otherwise specified, the “receiver device” may be a receiver device itself, or may be a component (such as a processor, a chip, or a chip system) in a receiver device, or may be a logic module or software that can implement all or some functions of a receiver device. The method includes: obtaining first information, where the first information indicates a frequency-domain resource mapping relationship for a reference signal associated with an antenna port; and receiving or sending the reference signal based on the frequency-domain resource mapping relationship for the reference signal.

Based on the second aspect, a transmitter device may dynamically switch the frequency-domain resource mapping relationship for the reference signal based on the first information, so that a better frequency-domain sampling position can be dynamically obtained while a quantity of antenna ports is increased, improving accuracy of channel estimation, and improving communication performance.

In some embodiments, the first information includes a random number seed.

In some embodiments, the first information further includes a frequency-domain sampling number of the reference signal.

Based on the foregoing embodiments, the transmitter device may send the random number seed (and the frequency-domain sampling number of the reference signal) to the receiver device based on the first information, so that signaling overheads can be reduced while the receiver device can determine the frequency-domain resource mapping relationship based on the random number seed and the frequency-domain sampling number of the reference signal.

In some embodiments, the first information further indicates that a frequency-domain resource mapping relationship interval for the reference signal is a third frequency-domain resource mapping relationship interval.

The third frequency-domain resource mapping relationship interval may be a region that has high frequency-domain density (for example, a large frequency-domain sampling number) and that is less sensitive to a resource position for the reference signal. For all frequency-domain resource mapping relationship intervals that have this characteristic (including but not limited to the third frequency-domain resource mapping relationship interval), the random number seed and the frequency-domain sampling number of the reference signal can be used to indicate the frequency-domain resource mapping relationship, to improve reliability of the frequency-domain resource mapping relationship.

In some embodiments, a pseudo-random sequence is determined based on the random number seed; a subcarrier associated with each of one or more frequency-domain resources associated with the reference signal is determined based on the pseudo-random sequence and the frequency-domain sampling number of the reference signal; and the frequency-domain resource mapping relationship is determined based on a position that is of a subcarrier associated with the reference signal and that is in the third frequency-domain resource mapping relationship interval.

The receiver device may determine the frequency-domain resource mapping relationship based on the random number seed and the frequency-domain sampling number of the reference signal, providing a feasible solution for determining the frequency-domain resource mapping relationship.

In some embodiments, the first information includes a frequency-domain sampling sequence index.

The transmitter device may send the frequency-domain sampling sequence index to the receiver device based on the first information, so that signaling overheads can be reduced while the receiver device can determine the frequency-domain resource mapping relationship based on the frequency-domain sampling sequence index.

In some embodiments, the first information further indicates that a frequency-domain resource mapping relationship interval for the reference signal is a second frequency-domain resource mapping relationship interval.

The second frequency-domain resource mapping relationship interval may be a region in which the frequency-domain sampling number is equivalent to the rank of the frequency-domain channel matrix or the first value. For all frequency-domain resource mapping relationship intervals that have this characteristic (including but not limited to the second frequency-domain resource mapping relationship interval), the frequency-domain sampling sequence index can be used to indicate the frequency-domain resource mapping relationship, to improve reliability of the frequency-domain resource mapping relationship.

In some embodiments, a frequency-domain sampling sequence associated with the frequency-domain sampling sequence index is determined from a preset correspondence based on the frequency-domain sampling sequence index, where the preset correspondence includes the frequency-domain sampling sequence index and the frequency-domain sampling sequence associated with the frequency-domain sampling sequence index; a subcarrier associated with each of one or more frequency-domain resources associated with the reference signal is determined based on the frequency-domain sampling sequence; and the frequency-domain resource mapping relationship is determined based on a position that is of a subcarrier associated with the reference signal and that is in the second frequency-domain resource mapping relationship interval.

The receiver device may determine the frequency-domain resource mapping relationship based on the frequency-domain sampling sequence index, providing a feasible solution for determining the frequency-domain resource mapping relationship.

In some embodiments, the preset correspondence is predefined; or the preset correspondence is received from a transmitter device.

In some embodiments, the first information includes a bitmap, where the bitmap indicates a subcarrier associated with each of one or more frequency-domain resources associated with the reference signal.

The transmitter device may send the bitmap to the receiver device based on the first information, to improve reliability of the frequency-domain resource mapping relationship.

In some embodiments, the first information further indicates that a frequency-domain resource mapping relationship interval for the reference signal is a first frequency-domain resource mapping relationship interval.

The first frequency-domain resource mapping relationship interval may be a region that has extremely low frequency-domain density and that is very sensitive to a resource position for the reference signal. For all frequency-domain resource mapping relationship intervals that have this characteristic (including but not limited to the first frequency-domain resource mapping relationship interval), the bitmap can be used to indicate the frequency-domain resource mapping relationship, to improve reliability of the frequency-domain resource mapping relationship.

In some embodiments, the frequency-domain resource mapping relationship indicates a position that is of a subcarrier associated with the reference signal and that is in the first frequency-domain resource mapping relationship interval.

In some embodiments, first indication information is received from the transmitter device, where the first indication information indicates the frequency-domain resource mapping relationship interval for the reference signal.

The transmitter device may explicitly indicate the frequency-domain resource mapping relationship interval for the reference signal by using the first indication information.

In some embodiments, the first indication information includes a rank of a frequency-domain channel matrix, a first value, and the frequency-domain sampling number of the reference signal, where the first value is a quantity of singular values that meet a first condition and that are in a singular value decomposition result of the frequency-domain channel matrix, and the first condition is that a difference between a reconstructed matrix corresponding to a singular value and the frequency-domain channel matrix is less than or equal to a first threshold; or the first indication information includes an interval index of the frequency-domain resource mapping relationship interval for the reference signal; or the first indication information includes interval frequency-domain range information of the frequency-domain resource mapping relationship interval for the reference signal; or the first indication information includes interval position information of the frequency-domain resource mapping relationship interval for the reference signal.

A plurality of feasible solutions are provided for design of the first indication information.

In some embodiments, in response to the first indication information including the rank of the frequency-domain channel matrix, the first value, and the frequency-domain sampling number of the reference signal, in response to the frequency-domain sampling number of the reference signal being less than or equal to the first value, the frequency-domain resource mapping relationship interval for the reference signal is the first frequency-domain resource mapping relationship interval; or in response to the frequency-domain sampling number of the reference signal being greater than the first value and being less than or equal to the rank of the frequency-domain channel matrix, the frequency-domain resource mapping relationship interval for the reference signal is the second frequency-domain resource mapping relationship interval; or in response to the frequency-domain sampling number of the reference signal being greater than the rank of the frequency-domain channel matrix, the frequency-domain resource mapping relationship interval for the reference signal is the third frequency-domain resource mapping relationship interval.

According to a third aspect, an embodiment provides a communication apparatus. The communication apparatus may be used in the transmitter device in the first aspect, to implement functions performed by the transmitter device. The communication apparatus may be a transmitter device, or may be a chip, a chip system, a system on chip, or the like of a transmitter device. The communication apparatus may perform, by hardware or by hardware executing corresponding software, the functions performed by the transmitter device. The hardware or the software includes one or more modules corresponding to the foregoing functions, for example, a transceiver module and a processing module. The transceiver module may independently complete the following sending and receiving operations, or may cooperate with the processing module to complete the following sending and receiving operations. Correspondingly, the processing module may independently complete the following processing operation, or may cooperate with the transceiver module to complete the following processing operation. This is not limited.

For example, the processing module is configured to determine, based on a frequency-domain channel matrix associated with an antenna port and a frequency-domain sampling number of a reference signal associated with the antenna port, a frequency-domain resource mapping relationship for the reference signal; the transceiver module is configured to send first information to a receiver device, where the first information indicates the frequency-domain resource mapping relationship for the reference signal; and the transceiver module is further configured to send or receive the reference signal based on the frequency-domain resource mapping relationship for the reference signal.

In some embodiments, the transceiver module and the processing module of the communication apparatus in the third aspect may further perform corresponding functions in the first aspect or any embodiment of the first aspect. For details, refer to the detailed descriptions in the method examples. For beneficial effects that can be achieved, refer to the foregoing related content.

According to a fourth aspect, an embodiment provides a communication apparatus. The communication apparatus may be used in the receiver device in the second aspect, to implement functions performed by the receiver device. The communication apparatus may be a receiver device, or may be a chip, a chip system, a system on chip, or the like of a receiver device. The communication apparatus may perform, by hardware or by hardware executing corresponding software, the functions performed by the receiver device. The hardware or the software includes one or more modules corresponding to the foregoing functions, for example, a transceiver module and a processing module. The transceiver module may independently complete the following sending and receiving operations, or may cooperate with the processing module to complete the following sending and receiving operations. Correspondingly, the processing module may independently complete the following processing operation, or may cooperate with the transceiver module to complete the following processing operation. This is not limited.

For example, the transceiver module is configured to obtain first information, where the first information indicates a frequency-domain resource mapping relationship for a reference signal associated with an antenna port; and the transceiver module is further configured to receive or send the reference signal based on the frequency-domain resource mapping relationship for the reference signal.

In some embodiments, the transceiver module and the processing module of the communication apparatus in the fourth aspect may further perform corresponding functions in the second aspect or any embodiment of the second aspect. For details, refer to the detailed descriptions in the method examples. For beneficial effects that can be achieved, refer to the foregoing related content.

According to a fifth aspect, an embodiment provides a communication apparatus. The communication apparatus includes one or more processors. The one or more processors are configured to run a computer program or instructions. When the one or more processors execute computer instructions or instructions, the reference signal transmission method according to any one of the first aspect and the second aspect is performed.

In some embodiments, the communication apparatus further includes one or more memories, the one or more memories are coupled to the one or more processors, and the one or more memories are configured to store the foregoing computer program or instructions. In some embodiments, the memory is located outside the communication apparatus. In some embodiments, the memory is located inside the communication apparatus. In an embodiment, the processor and the memory may alternatively be integrated into one component. In other words, the processor and the memory may alternatively be integrated together. In some embodiments, the communication apparatus further includes a transceiver. The transceiver is configured to receive information and/or send information.

In some embodiments, the communication apparatus further includes one or more communication interfaces, the one or more communication interfaces are coupled to the one or more processors, and the one or more communication interfaces are configured to communicate with a module other than the communication apparatus.

According to a sixth aspect, an embodiment provides a communication apparatus. The communication apparatus includes an interface circuit and a logic circuit. The interface circuit is configured to input and/or output information. The logic circuit is configured to perform the reference signal transmission method according to any one of the first aspect and the second aspect, to perform processing based on the information and/or generate the information.

According to a seventh aspect, an embodiment provides a non-transitory computer-readable storage medium. The non-transitory computer-readable storage medium stores computer instructions or a program. When the computer instructions or the program is run on a computer, the reference signal transmission method according to any one of the first aspect and the second aspect is performed.

According to an eighth aspect, an embodiment provides a computer program product including computer instructions. When the computer program product is run on a computer, the reference signal transmission method according to any one of the first aspect and the second aspect is performed.

According to a ninth aspect, an embodiment provides a computer program. When the computer program is run on a computer, the reference signal transmission method according to any one of the first aspect and the second aspect is performed.

According to a tenth aspect, an embodiment provides a chip including a processor. The processor is coupled to a memory. The memory is configured to store a program or instructions. When the program or the instructions are executed by the processor, the reference signal transmission method according to any one of the first aspect and the second aspect is performed.

For technical effects brought by any embodiment in the fifth aspect to the tenth aspect, refer to the technical effects brought by any one of the first aspect and the second aspect. Details are not described again.

According to an eleventh aspect, an embodiment provides a communication system. The communication system may include the communication apparatus configured to perform the first aspect or any embodiment of the first aspect and the communication apparatus configured to perform the second aspect or any embodiment of the second aspect.

### BRIEF DESCRIPTION OF DRAWINGS

FIG. 1A and FIG. 1B are diagrams of a correspondence between an DMRS and a port according to an embodiment;

FIG. 2A and FIG. 2B are diagrams of a correspondence among a port quantity, a frequency-domain sampling interval, and aliasing energy according to an embodiment;

FIG. 3A to FIG. 3C are diagrams of a communication system according to an embodiment;

FIG. 4 is a diagram of composition of a communication apparatus according to an embodiment;

FIG. 5 is a flowchart of a reference signal transmission method according to an embodiment;

FIG. 6 is a flowchart of determining a frequency-domain resource mapping relationship interval for a reference signal according to an embodiment;

FIG. 7 is a diagram of a frequency-domain resource mapping relationship interval for a reference signal according to an embodiment;

FIG. 8 is a flowchart of a reference signal transmission method according to an embodiment;

FIG. 9 is a diagram of a method for determining a frequency-domain resource mapping relationship for a reference signal according to an embodiment;

FIG. 10 is a flowchart of a reference signal transmission method according to an embodiment;

FIG. 11A to FIG. 11C are diagrams of a typical frequency-domain resource mapping relationship in a frequency-domain resource mapping relationship interval for a reference signal according to an embodiment;

FIG. 12 is a diagram of a method for determining a frequency-domain resource mapping relationship for a reference signal according to an embodiment;

FIG. 13 is a diagram of a frequency-domain sampling sequence according to an embodiment;

FIG. 14 is a flowchart of a reference signal transmission method according to an embodiment;

FIG. 15 is a diagram of a method for determining a frequency-domain resource mapping relationship for a reference signal according to an embodiment;

FIG. 16 is a diagram of a method for determining a bitmap according to an embodiment;

FIG. 17 is a flowchart of a reference signal transmission method according to an embodiment;

FIG. 18 is a diagram of a communication apparatus according to an embodiment; and

FIG. 19 is a diagram of composition of a communication apparatus according to an embodiment.

### DESCRIPTION OF EMBODIMENTS

Before embodiments are described, technical terms used in embodiments of this disclosure are described.

With continuous development of communication technologies, wireless communication systems undergo evolution and research from first generation analog communication to a fifth generation (5G) new radio (NR) communication system and a 6G technology. In this complex evolution process, high throughput and massive connectivity have always been core challenges for wireless communication networks.

In various 5G NR and 6G solutions, a massive multiple-input multiple-output (massive MIMO) technology that can significantly increase system capacity, as a key technology, can meet high-rate transmission criteria. According to the Massive MIMO technology, an array gain, multiplexing and diversity gains, and a co-channel interference reduction gain in space can be obtained for a signal by using resources in spatial dimensions without increasing a system bandwidth, exponentially improving capacity and spectral efficiency of a communication system.

In the Massive MIMO technology, to send and receive data, achieve system synchronization, and feed back channel information, it is more important to estimate an uplink channel or a downlink channel. Channel estimation is a process of reconstructing or restoring a reception channel to compensate for signal distortion caused by channel fading and noise-induced fading, where changes in time domain and frequency domain of a channel can be tracked by using a standard signal pre-known by a transmitter and a receiver. The standard signal may also be referred to as a pilot signal or a reference signal (RS). Standard signals are distributed on different resource elements (RE) in time-frequency two-dimensional space in an orthogonal frequency division multiplexing (OFDM) symbol, and have known amplitudes and phases.

To implement channel quality measurement in the Massive MIMO technology, a 5G NR system separately defines the following reference signals: a sounding reference signal (SRS), a channel state information reference signal (CSI-RS), a demodulation reference signal (DMRS), and the like.

The SRS can be used for uplink channel measurement. A network device may estimate an uplink channel based on an SRS sent by a terminal device, and perform, based on a channel estimation result, frequency-selective resource scheduling, power control, timing estimation and modulation/coding scheme order selection, downlink precoding generation in time division duplex (TDD), and the like. This is not limited.

The CSI-RS can be used for downlink channel measurement corresponding to a physical antenna port (or may be referred to as an antenna port, a port, or the like). A terminal device may perform channel estimation for each port sent by a network device, and feed back channel state information (CSI) based on a channel estimation result. The CSI may include related information such as a channel quality indicator (CQI), a rank indicator (RI), a precoding matrix indicator (PMI), and a layer indicator (LI).

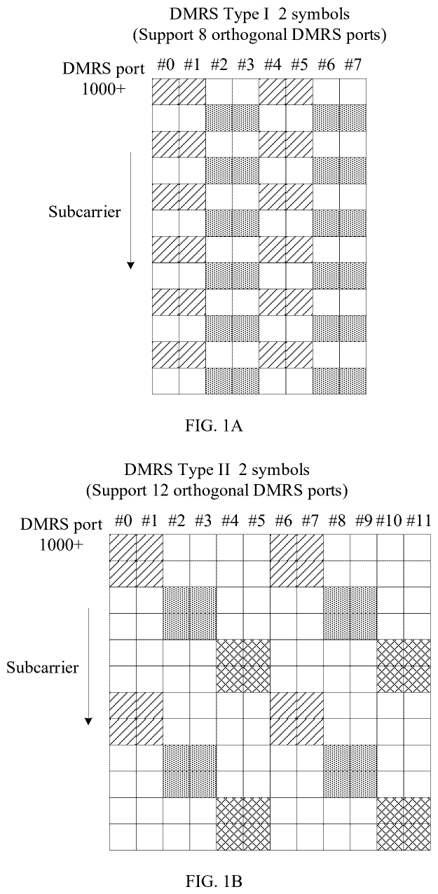

The DMRS can be used to assist in demodulation on a physical downlink shared channel (PDSCH). The DMRS may include DMRS type I and DMRS type II. As shown in FIG. 1A, in Rel-15, DMRS Type I can support a maximum of eight ports, and corresponding frequency-domain density is one resource block (RB) corresponding to three REs (for example, 3RE/RB). As shown in FIG. 1B, DMRS Type II can support a maximum of 12 ports, and corresponding frequency-domain density is 2RE/RB.

A DMRS used for a PDSCH (for example, DMRS for PDSCH) may have the following characteristics.

(1) Front-loaded DMRS (FL DMRS) and add-on DMRS: The FL DMRS occupies one to two OFDM symbols (for example, an OFDM symbol 2 and an OFDM symbol 3). For the FL DMRS occupying one OFDM symbol, the add-on DMRS occupies three OFDM symbols. Alternatively, for the FL DMRS occupying two OFDM symbols, the add-on DMRS occupies zero to two OFDM symbols.

(2) A rule is mapped to each scheduled unit (where the scheduled unit may be a physical resource block pair (PRB pair)). There is complete port mapping on any scheduled PRB (for example, each port is mapped to each scheduled unit). There is complete port mapping in any scheduled slot.

(3) DMRS PRB bundling (DMRS PRB bundling): Consecutive PRBs are used as a bundle or a precoding resource block group (PRG) for frequency-domain joint processing, to improve reception performance.

(4) DMRS rate matching (DMRS RM): indicating a number of code division multiplexing (CDM) groups that are occupied, to determine RM information.

Based on the foregoing description of the reference signal, sparsification of time-frequency resources for the reference signal is one of primary approaches to achieving a higher number of transmission streams.

A quantity of antenna ports may be increased to implement sparsification of time-frequency resources for reference signals and achieve a higher number of transmission streams, so as to improve communication performance.

For example, the reference signal is a DMRS. In the communication release 18 (Rel-18), DMRS Type I and DMRS Type II may be enhanced to obtain DMRS eType I and DMRS eType II. DMRS eType I can support a maximum of 16 ports, and corresponding frequency-domain density is 3RE/2RB. DMRS eType II can support a maximum of 24 ports, and corresponding frequency-domain density is 1RE/RB. The frequency-domain density of DMRS eType I and the frequency-domain density of DMRS eType II are halved respectively relative to the frequency-domain density of DMRS Type I and the frequency-domain density of DMRS Type II, so that sparsification of time-frequency resources for the reference signal can be implemented.

To keep total overheads of reference signals unchanged, in response to a quantity of antenna ports increasing, time-frequency domain density of the antenna ports is correspondingly reduced. The time-frequency domain density may be reduced by increasing a sampling interval. However, the increase of the sampling interval leads to reduction of a sampling bandwidth, causing a high proportion of aliasing energy, consequently affecting accuracy of channel estimation.

For example, the reference signal is a DMRS. A DMRS design method may be based on a frequency-domain uniform sampling theorem (for example, the Nyquist sampling theorem), and an actual Wiener filter is used for a terminal device performing channel estimation. The actual Wiener filter assumes that a channel delay power spectrum meets a specific distribution (for example, a negative exponential distribution). Within a channel frequency-domain coherence bandwidth, interpolation filtering performance is positively correlated with the frequency-domain density of the reference signal.

The delay power spectrum may be

$${R}_{p} ( τ ) = \frac{1}{{τ}_{RM S}} \cdot {e}^{- \frac{\vert τ \vert}{{τ}_{RM S}}} , τ ∈ [ - {Δ}_{m} {τ}_{RM S} , ( {Δ}_{ma x} - {Δ}_{m} ) {τ}_{R M S} ] ;$$

a delay frequency-domain autocorrelation function may be

$${R}_{Ψ {Ψ}_{r s}^{H}} ( n , m ) = FFT \{ {R}_{p} ( τ ) \} {\vert}_{f = ( n - m ) \cdot Δ f} ;$$

and
an actual Wiener filtering coefficient may be

$$W = {R}_{Ψ {Ψ}_{r s}^{H}} \cdot {( {R}_{{Ψ}_{r s} {Ψ}_{r s}^{H}} + \frac{1}{SNR} {I}_{rs} )}^{- 1} ,$$

where
p represents a p^{th} DMRS port; t represents a multipath delay; τ_{RMS} represents a root mean square (RMS) of the multipath delay τ; Δₘ represents a timing offset; Δₘₐₓ represents a maximum value of a multipath delay offset; n represents an n^{th} frequency-domain position; m represents an m^{th} frequency-domain position; f represents frequency; FFT represents fast Fourier transform;

$${R}_{{Ψ}_{r s} {Ψ}_{r s}^{H}}$$

represents a covariance matrix if a channel matrix at a time-frequency resource position of the reference signal; Iᵣₛ represents an identity matrix of same dimensions as

$${R}_{{Ψ}_{r s} {Ψ}_{r s}^{H}} ;$$

and SNR represents a signal-to-noise ratio.

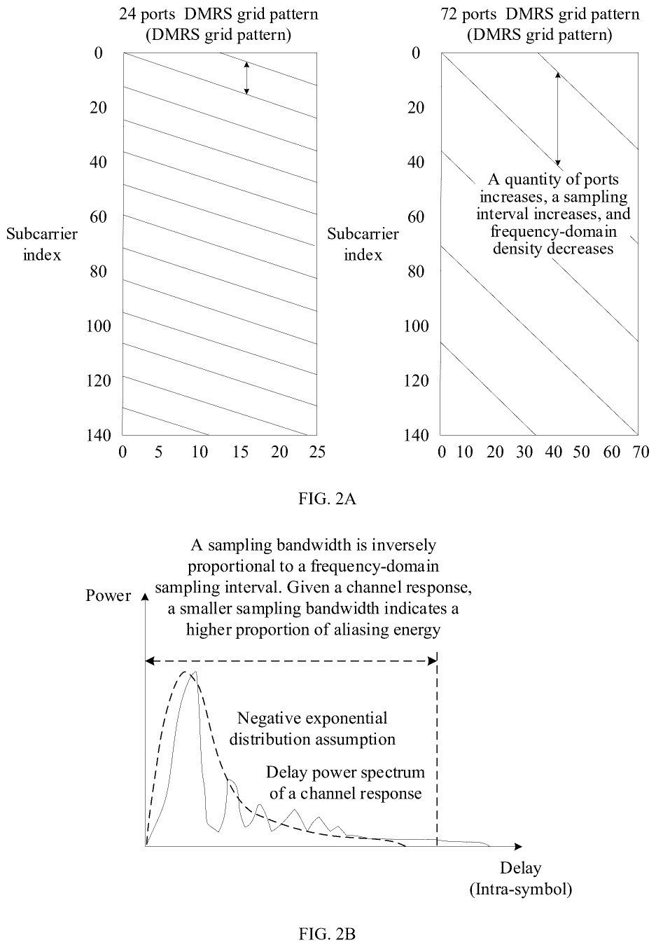

Assuming that total DMRS overheads remain unchanged, as shown in FIG. 2A, after a quantity of orthogonal DMRS ports is increased (for example, from 24 ports to 72 ports), frequency-domain density of specific DMRS ports is correspondingly reduced. The frequency-domain density may be reduced by increasing a sampling interval. However, as shown in FIG. 2B, the increase of the sampling interval leads to reduction of a sampling bandwidth, causing energy aliasing in a delay power spectrum of a DMRS channel response due to undersampling, consequently posing severe challenges to channel estimation of a terminal device.

In conclusion, how to improve accuracy of channel estimation while increasing a quantity of antenna ports becomes a technical problem to be urgently resolved.

To resolve the technical problem, embodiments of this disclosure provide a reference signal transmission method. In the method, a transmitter device may determine, based on a frequency-domain channel matrix associated with an antenna port and a frequency-domain sampling number of a reference signal associated with the antenna port, a frequency-domain resource mapping relationship for the reference signal; and send first information to a receiver device, where the first information indicates the frequency-domain resource mapping relationship for the reference signal; and the transmitter device may further send or receive the reference signal based on the frequency-domain resource mapping relationship for the reference signal.

In embodiments of this disclosure, the transmitter device may dynamically determine the frequency-domain resource mapping relationship for the reference signal based on the frequency-domain channel matrix associated with the antenna port and the frequency-domain sampling number of the reference signal associated with the antenna port, and dynamically switch the frequency-domain resource mapping relationship for the reference signal based on the first information, so that a better frequency-domain sampling position can be dynamically obtained while a quantity of antenna ports is increased, improving accuracy of channel estimation, and improving communication performance.

The following describes embodiments in detail with reference to accompanying drawings in this specification.

The reference signal transmission method provided in embodiments of this disclosure may be applied to any communication system. The communication system may be a third generation partnership project (3GPP) communication system, for example, a long term evolution (LTE) system, or may be a fifth generation (5G) mobile communication system, an LTE-5G hybrid networking system, a new radio (NR) system, an NR vehicle-to-everything (V2X) system, a TDD system, a frequency-division duplex (FDD) system, a device-to-device (D2D) communication system, a machine-to-machine (M2M) communication system, Internet of Things (IoT), a narrowband-Internet of Things (NB-IoT) system, a global system for mobile communications (GSM), an enhanced data rate for GSM evolution (EDGE) system, a wideband code division multiple access (WCDMA) system, a code division multiple access 2000 (CDMA2000) system, a time division-synchronization code division multiple access (TD-SCDMA) system, enhanced mobile broadband (eMBB), ultra-reliable and low-latency communication (URLLC), enhanced machine-type communication (eMTC), and various next-generation communication systems, for example, a sixth generation (6G) mobile communication system, or may be a non-terrestrial network (NTN) system, a non-3GPP communication system, or the like. This is not limited.

Embodiments may be applied to a communication scenario such as a homogeneous network scenario, a heterogeneous network scenario, a coordinated multi-point transmission/reception scenario (such as a macro base station and a macro base station, a micro base station and a micro base station, or a macro base station and a micro base station), a low-frequency (below 6 GHZ) scenario, a high-frequency (above 6 GHz) scenario, a single transmission reception point (single-TRP) scenario, a multi-TRP scenario, or any scenario derived from single-TRP or multi-TRP. This is not limited.

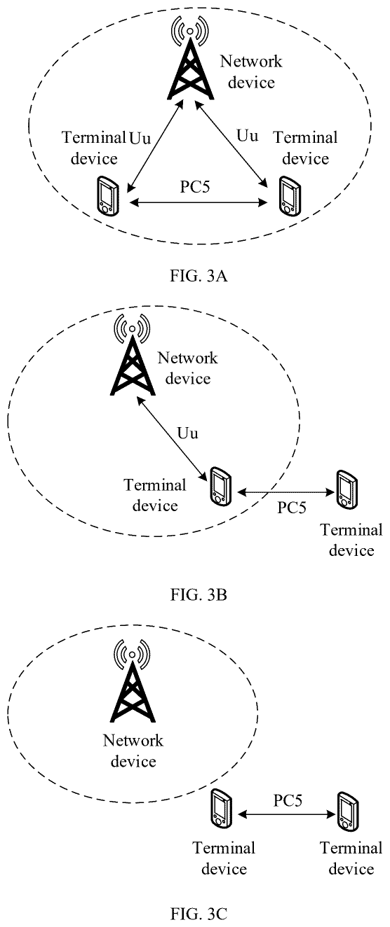

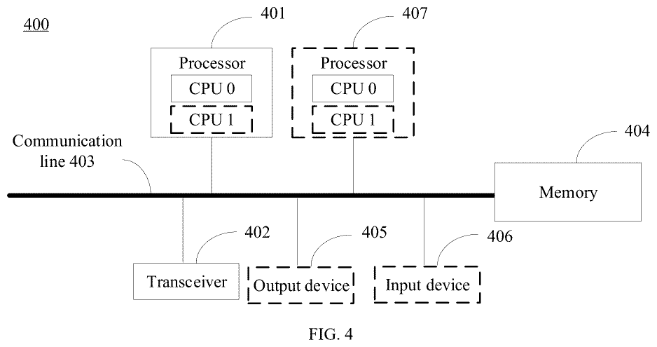

The following uses FIG. 3A to FIG. 3C as examples to describe a communication system provided in embodiments.

The communication system provided in embodiments of this disclosure may include one or more transmitter devices and one or more receiver devices.

For example, as shown in FIG. 3A, the transmitter device and the receiver device may be respectively a network device and a terminal device. In other words, embodiments are applicable to a communication process between the network device and the terminal device, and are applicable to a communication scenario with network coverage. Alternatively, as shown in FIG. 3B or FIG. 3C, the transmitter device and the receiver device may be different terminal devices. In other words, embodiments are applicable to a communication process between the terminal devices. The terminal device may be located within coverage of a network device, or may be located outside coverage of the network device. In other words, embodiments are applicable to a communication scenario with network coverage and a communication scenario without network coverage. This is not limited.

The terminal device in FIG. 3A to FIG. 3C may be a device with a wireless transceiver function or a chip or chip system that can be disposed in the device, can allow a user to access a network, and is a device configured to provide voice and/or data connectivity for the user. The terminal device may communicate with the network device through a Uu interface, or the terminal device may communicate with the terminal device through a PC5 interface. The terminal device may also be referred to as user equipment (UE), a subscriber unit, a terminal, a mobile station (MS), a mobile terminal (MT), or the like.

For example, the terminal device in FIG. 3A to FIG. 3C may be a mobile phone, a tablet computer, or a computer with a wireless transceiver function. Alternatively, the terminal device may be a subscriber station, a mobile station, a remote station, a remote terminal device, a mobile terminal device, a user terminal device, a wireless communication device, a user agent, a user apparatus, a cellular phone, a cordless phone, a session initiation protocol (SIP) phone, a wireless local loop (WLL) station, a personal digital assistant (PDA), a handheld device with a wireless communication function, a compute device, a processing device connected to a wireless modem, an on-board device, a wearable device, a terminal device in Internet of Things, a household appliance, a virtual reality (VR) terminal, an augmented reality (AR) terminal, a wireless terminal in industrial control, a wireless terminal in self driving, a wireless terminal in remote medical, a wireless terminal in a smart grid, a wireless terminal in a smart city, a wireless terminal in a smart home, a vehicle with a vehicle-to-vehicle (V2V) communication capability, an on-board communication module or another embedded communication module, an intelligent connected vehicle, an unmanned aerial vehicle with a UAV-to-UAV (U2U) communication capability, a terminal device in a future network, a terminal device in a future evolved public land mobile network (PLMN), or the like. This is not limited.

The network device in FIG. 3A to FIG. 3C may be any device that is deployed in an access network and that can perform wireless communication with the terminal device, or may be a chip or chip system that can be disposed in the device, or may be a logic node or a logic module or a function implemented in a software manner, and may be configured to implement functions such as radio physical control, resource scheduling and radio resource management, radio access control, and mobility management. The network device may be a device supporting wired access, or may be a device supporting wireless access.

For example, the network device may include one or more access network (AN) or radio access network (RAN) nodes. The AN/RAN node may be a NodeB (NB), a macro base station, a micro base station (or described as a small cell), a picocell base station, a balloon station, a relay station, an enhanced NodeB (eNB), a next-generation NodeB (gNB), a home base station (for example, a home evolved NodeB or a home NodeB, HNB), a base station in a 5G communication system, a base station in a future mobile communication system, an access point (AP) in a wireless-fidelity (Wi-Fi) system, a TRP, a transmission point (TP), a transmission measurement function (TMF), a radio network controller (RNC), a base station controller (BSC), a base transceiver station (BTS), a wearable device, an on-board device, another access node, or the like. This is not limited.

In another example, in a distributed base station scenario, the network device may include a baseband unit (BBU) and a remote radio unit (RRU). The BBU and the RRU may be placed at different places. For example, the RRU is remote and placed in a heavy-traffic area, and the BBU is placed in a central equipment room. Alternatively, the BBU and the RRU may be placed in a same equipment room. Alternatively, the BBU and the RRU may be different components at a same rack.

In still another example, in a cloud radio access network (CRAN) scenario, the network device may include a baseband pool (BBU pool) and an RRU.

In still another example, the network device may be a device including a central unit (CU) node, or including a distributed unit (DU) node, or including a CU node and a DU node. For example, the network device may be divided into a CU and a DU from a perspective of logical functions. Some protocol layer functions are centrally controlled by the CU, remaining or all protocol layer functions are distributed in the DU, and the CU centrally controls the DU. Further, the central unit CU may be further divided into a control plane (CU-CP) and a user plane (CU-UP). In different systems, the CU (including the CU-CP or the CU-UP) or the DU may have different names. For example, in an open radio access network (O-RAN) system, the CU may also be referred to as an O-CU (open CU), the DU may also be referred to as an O-DU, the CU-CP may also be referred to as an O-CU-CP, and the CU-UP may also be referred to as an O-CU-UP.

It should be noted that the transmitter device and the receiver device in embodiments of this disclosure each may be one or more chips, or may be a system on chip (SOC), or the like. FIG. 3A to FIG. 3C are merely example figures, and a quantity of included devices is not limited. Moreover, in addition to the devices shown in FIG. 3A to FIG. 3C, the communication system may further include another device, for example, may further include a wireless relay device and a wireless backhaul device. Names of the devices and links in FIG. 3A to FIG. 3C are not limited. In addition to the names shown in FIG. 3A to FIG. 3C, the devices and links may further have other names. This is not limited.

During implementation, as shown in FIG. 3A to FIG. 3C, for example, each transmitter device or each receiver device may use a composition structure shown in FIG. 4, or include components shown in FIG. 4. FIG. 4 is a diagram of composition of a communication apparatus 400 according to an embodiment. The communication apparatus 400 may be a transmitter device or a chip or system on chip in a transmitter device, or may be a receiver device or a chip or system on chip in a receiver device. As shown in FIG. 4, the communication apparatus 400 includes a processor 401, a transceiver 402, and a communication line 403.

Further, the communication apparatus 400 may further include a memory 404. The processor 401, the memory 404, and the transceiver 402 may be connected through the communication line 403.

The processor 401 is a central processing unit (CPU), a general-purpose processor, a network processor (NP), a digital signal processor (DSP), a microprocessor, a microcontroller, a programmable logic device (PLD), or any combination thereof. Alternatively, the processor 401 may be another apparatus with a processing function, such as a circuit, a component, or a software module. This is not limited.

The transceiver 402 is configured to communicate with another device or another communication network. The another communication network may be Ethernet, a radio access network (RAN), a wireless local area network (WLAN), or the like. The transceiver 402 may be a module, a circuit, a transceiver, or any apparatus that can implement communication.

The communication line 403 is configured to transmit information between the components included in the communication apparatus 400.

The memory 404 is configured to store instructions. The instructions may be computer programs.

The memory 404 may be a read-only memory (ROM) or another type of static storage device that can store static information and/or instructions; or may be a random access memory (RAM) or another type of dynamic storage device that can store information and/or instructions; or may be an electrically erasable programmable read-only memory (EEPROM), a compact disc read-only memory (CD-ROM) or another compact disc storage, an optical disc storage (including a compact optical disc, a laser disc, an optical disc, a digital versatile optical disc, a Blu-ray optical disc, or the like), a magnetic disk storage medium or another magnetic storage device, or the like. This is not limited.

It should be noted that the memory 404 may be independent of the processor 401, or may be integrated with the processor 401. The memory 404 may be configured to store instructions, program code, some data, or the like. The memory 404 may be located inside the communication apparatus 400, or may be located outside the communication apparatus 400. This is not limited. The processor 401 is configured to execute the instructions stored in the memory 404, to implement the reference signal transmission method provided in the following embodiments.

In an example, the processor 401 may include one or more CPUs, for example, a CPU 0 and a CPU 1 in FIG. 4.

In some embodiments, the communication apparatus 400 includes a plurality of processors. For example, the communication apparatus 400 may further include a processor 407 in addition to the processor 401 in FIG. 4.

In some embodiments, the communication apparatus 400 further includes an output device 405 and an input device 406. For example, the input device 406 is a keyboard, a mouse, a microphone, a joystick, or another device, and the output device 405 is a display, a speaker, or another device.

It should be noted that the communication apparatus 400 may be a desktop computer, a portable computer, a network server, a mobile phone, a tablet computer, a wireless terminal, an embedded device, a chip system, or a device of a structure similar to that in FIG. 4. In addition, the composition structure shown in FIG. 4 does not constitute a limitation on the communication apparatus. In addition to the components shown in FIG. 4, the communication apparatus may include more or fewer components than those shown in the figure, or some components may be combined, or different component arrangements may be used.

In an embodiment, the chip system may include a chip, or may include a chip and another discrete component.

In addition, actions, terms, and the like in embodiments of this disclosure may be mutually referenced. This is not limited. In embodiments of this disclosure, names of messages exchanged between devices, names of parameters in the messages, or the like are merely examples. Other names may alternatively be used during implementation. This is not limited.

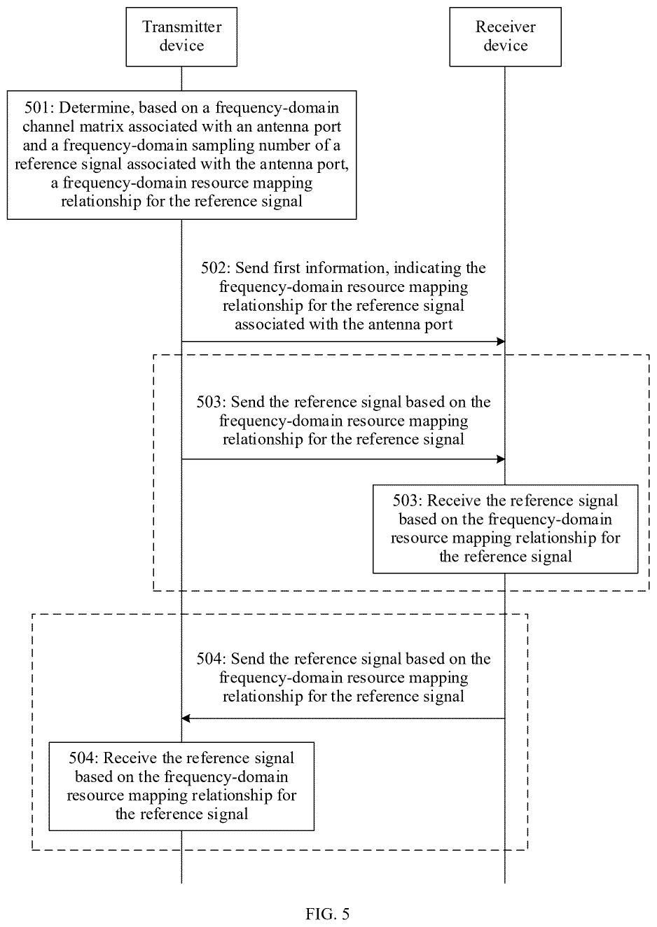

With reference to the communication system shown in FIG. 3A to FIG. 3C, as shown in FIG. 5, the reference signal transmission method provided in embodiments of this disclosure is described. A transmitter device may be the network device or the terminal device in the communication system shown in FIG. 3A to FIG. 3C, and a receiver device may be the terminal device in the communication system shown in FIG. 3A to FIG. 3C. Both the transmitter device and the receiver device in the following embodiments may have the components shown in FIG. 4. Processing performed by a single execution body (the transmitter device or the receiver device) shown in embodiments of this disclosure may be divided into processing performed by a plurality of execution bodies. These execution bodies may be logically and/or physically separated. This is not limited.

FIG. 5 is a flowchart of a reference signal transmission method according to an embodiment. As shown in FIG. 5, the method may include the following steps.

Step 501: The transmitter device determines, based on a frequency-domain channel matrix associated with an antenna port and a frequency-domain sampling number of a reference signal associated with the antenna port, a frequency-domain resource mapping relationship for the reference signal.

The frequency-domain resource mapping relationship for the reference signal may indicate a subcarrier associated with each of one or more frequency-domain resources associated with the reference signal.

In some embodiments, the transmitter device may determine a frequency-domain resource mapping relationship interval for the reference signal based on the frequency-domain channel matrix and the frequency-domain sampling number of the reference signal; and determine the frequency-domain resource mapping relationship for the reference signal based on the frequency-domain resource mapping relationship interval for the reference signal and the frequency-domain sampling number of the reference signal.

The frequency-domain channel matrix may indicate a user channel for frequency-domain information, and the frequency-domain sampling number may be another parameter that can indicate the frequency-domain sampling number. This is not limited.

For descriptions of the frequency-domain resource mapping relationship interval for the reference signal, refer to the following related descriptions in FIG. 6 to FIG. 8. Details are not described herein again.

In some embodiments, the transmitter device may perform singular value decomposition on the frequency-domain channel matrix, to obtain a singular value decomposition result; and determine the frequency-domain sampling number of the reference signal based on the singular value decomposition result.

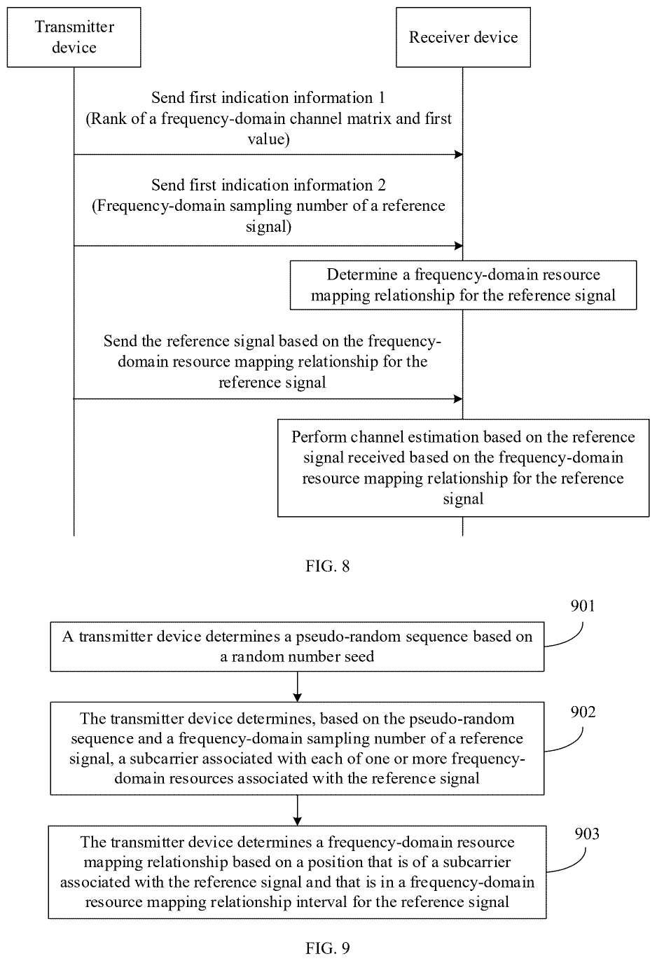

In some embodiments, the transmitter device may further determine the frequency-domain resource mapping relationship for the reference signal by using any one or more of the following methods shown in FIG. 9 to FIG. 17. Details are not described herein again.

Step 502: The transmitter device sends first information to a receiver device, and correspondingly, the receiver device receives the first information from the transmitter device.

The first information may indicate the frequency-domain resource mapping relationship for the reference signal associated with the antenna port.

In some embodiments, the receiver device may determine the frequency-domain resource mapping relationship for the reference signal based on the first information by using any one or more of the following methods shown in FIG. 9 to FIG. 17. Details are not described herein again.

In some embodiments, the transmitter device may include the first information in one or more of the following signaling: downlink control information (DCI), a media access control control element (MAC CE), radio resource control (RRC) signaling, and the like, and send the signaling to the receiver device. This is not limited.

Step 503: The transmitter device sends the reference signal based on the frequency-domain resource mapping relationship for the reference signal; and correspondingly, the receiver device receives the reference signal based on the frequency-domain resource mapping relationship for the reference signal.

In some embodiments, the receiver device may perform channel estimation based on the received reference signal.

Alternatively, step 503 may be replaced with step 504.

Step 504: The receiver device sends the reference signal based on the frequency-domain resource mapping relationship for the reference signal; and correspondingly, the transmitter device receives the reference signal based on the frequency-domain resource mapping relationship for the reference signal.

In some embodiments, the transmitter device may perform channel estimation based on the received reference signal.

Based on the method shown in FIG. 5, the transmitter device may dynamically determine the frequency-domain resource mapping relationship for the reference signal based on the frequency-domain channel matrix associated with the antenna port and the frequency-domain sampling number of the reference signal associated with the antenna port, and dynamically switch the frequency-domain resource mapping relationship for the reference signal based on the first information, so that a better frequency-domain sampling position can be dynamically obtained while a quantity of antenna ports is increased, improving accuracy of channel estimation, and improving communication performance.

Based on the method shown in FIG. 5, as shown in FIG. 6, the frequency-domain resource mapping relationship interval for the reference signal is described in detail.

FIG. 6 is a flowchart of determining a frequency-domain resource mapping relationship interval for a reference signal according to an embodiment. As shown in FIG. 6, the method may include the following steps.

Step 601: The transmitter device determines a rank of the frequency-domain channel matrix and a first value based on the frequency-domain channel matrix.

Dimensions of the frequency-domain channel matrix may be a number of receive antennas multiplied by a number of frequency-domain resources.

The first value may be a quantity of singular values that meet a first condition and that are in a singular value decomposition result of the frequency-domain channel matrix, and the first condition may be that a difference between a reconstructed matrix corresponding to a singular value and the frequency-domain channel matrix is less than or equal to a first threshold.

Step 602: The transmitter device determines the frequency-domain resource mapping relationship interval for the reference signal based on the rank of the frequency-domain channel matrix, the first value, and the frequency-domain sampling number of the reference signal.

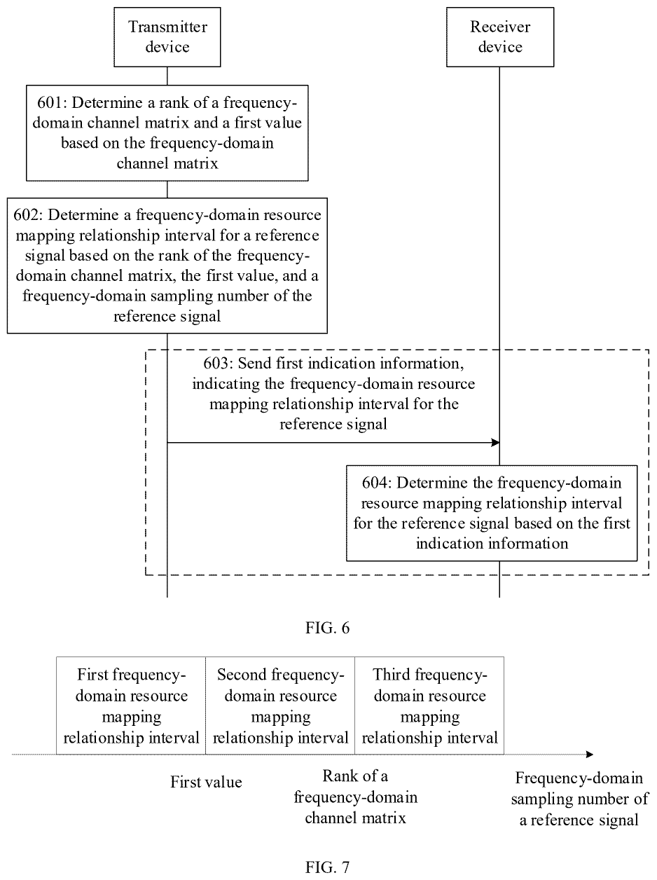

For example, as shown in FIG. 7, in response to the frequency-domain sampling number of the reference signal being less than or equal to the first value, the frequency-domain resource mapping relationship interval for the reference signal may be a first frequency-domain resource mapping relationship interval; or in response to the frequency-domain sampling number of the reference signal being greater than the first value and being less than or equal to the rank of the frequency-domain channel matrix, the frequency-domain resource mapping relationship interval for the reference signal may be a second frequency-domain resource mapping relationship interval; or in response to the frequency-domain sampling number of the reference signal being greater than the rank of the frequency-domain channel matrix, the frequency-domain resource mapping relationship interval for the reference signal may be a third frequency-domain resource mapping relationship interval.

In some embodiments, the transmitter device may further send first indication information to the receiver device according to step 603.

603: The transmitter device sends first indication information to the receiver device; and correspondingly, the receiver device receives the first indication information from the transmitter device.

Step 604: The receiver device determines the frequency-domain resource mapping relationship interval for the reference signal based on the first indication information.

The first indication information may indicate the frequency-domain resource mapping relationship interval for the reference signal.

In some embodiments, the first indication information may include the rank of the frequency-domain channel matrix, the first value, and the frequency-domain sampling number of the reference signal, where the first value is a quantity of singular values that meet the first condition and that are in a singular value decomposition result of the frequency-domain channel matrix, and the first condition is that a difference between a reconstructed matrix corresponding to a singular value and the frequency-domain channel matrix is less than or equal to the first threshold.

The receiver device may determine the frequency-domain resource mapping relationship interval for the reference signal based on the first indication information with reference to the foregoing description shown in FIG. 7.

In some embodiments, the transmitter device may include the rank of the frequency-domain channel matrix, the first value, and the frequency-domain sampling number of the reference signal in the same first indication information, and send the first indication information to the receiver device. Alternatively, as shown in FIG. 8, the transmitter device may include the rank of the frequency-domain channel matrix and the first value in first indication information 1 and include the frequency-domain sampling number of the reference signal in first indication information 2, for sending to the receiver device. This is not limited. Then, the receiver device may determine the frequency-domain resource mapping relationship interval for the reference signal based on the first indication information 1 and the first indication information 2, determine the frequency-domain resource mapping relationship for the reference signal based on the frequency-domain resource mapping relationship interval for the reference signal, and then perform channel estimation based on the reference signal received based on the frequency-domain resource mapping relationship for the reference signal.

In some embodiments, the first indication information 1 and the first indication information 2 may have cycles of different lengths, or may have cycles of a same length. This is not limited.

In some embodiments, the first indication information may include an interval index of the frequency-domain resource mapping relationship interval for the reference signal.

The receiver device may determine, from a preset mapping relationship based on the received first indication information, the frequency-domain resource mapping relationship interval corresponding to the interval index indicated by the first indication information.

The preset mapping relationship may indicate the interval index and the frequency-domain resource mapping relationship interval corresponding to the interval index.

For example, the preset mapping relationship may indicate that an interval index 00 corresponds to a first frequency-domain resource mapping relationship interval, an interval index 01 corresponds to a second frequency-domain resource mapping relationship interval, and an interval index 10 corresponds to a third frequency-domain resource mapping relationship interval.

In some embodiments, the preset mapping relationship may be predefined in a communication protocol. Alternatively, the preset mapping relationship may be determined by the transmitter device, and the transmitter device may send, to the receiver device, the preset mapping relationship determined by the transmitter device.

In some embodiments, the first indication information includes interval frequency-domain range information of the frequency-domain resource mapping relationship interval for the reference signal.

For example, the interval frequency-domain range information may include a minimum frequency-domain value and a maximum frequency-domain value of the frequency-domain resource mapping relationship interval.

In some embodiments, the first indication information includes interval position information of the frequency-domain resource mapping relationship interval for the reference signal.

For example, the interval position information may be absolute position information of the frequency-domain resource mapping relationship interval (for example, may be position information of the frequency-domain resource mapping relationship interval in frequency domain), or the interval position information may be relative position information of the frequency-domain resource mapping relationship interval (for example, may be position information of the frequency-domain resource mapping relationship interval relative to a start position in a frequency-domain range). This is not limited.

In some embodiments, the foregoing embodiments may be applied independently, or may be applied in combination. This is not limited.

Based on the foregoing description of the first indication information, in some embodiments, the transmitter device may include the first indication information in one or more of the following signaling: DCI, a MAC CE, RRC signaling, and the like, and send the signaling to the receiver device. This is not limited.

Based on the foregoing description, as shown in FIG. 9 to FIG. 17, the transmitter device and the receiver device determining the frequency-domain resource mapping relationship for the reference signal is described in detail.

FIG. 9 is a diagram of a method for determining a frequency-domain resource mapping relationship for a reference signal according to an embodiment. As shown in FIG. 9, the method may include the following steps.

Step 901: The transmitter device determines a pseudo-random sequence based on a random number seed.

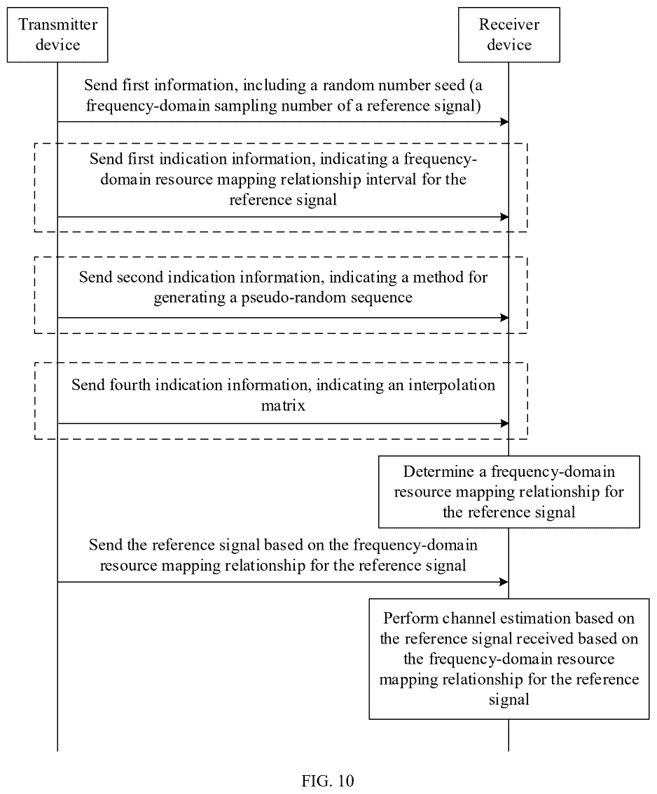

A method for generating the pseudo-random sequence based on the random number seed may be predefined in a protocol. Alternatively, the generation method may be determined by the transmitter device. In some embodiments, as shown in FIG. 10, the transmitter device may further indicate the generation method to the receiver device based on second indication information, for the receiver device to generate, according to the generation method and based on the random number seed indicated by the transmitter device, the pseudo-random sequence that is the same as that of the transmitter device.

Step 902: The transmitter device determines, based on the pseudo-random sequence and the frequency-domain sampling number of the reference signal, a subcarrier associated with each of one or more frequency-domain resources associated with the reference signal.

Step 903: The transmitter device determines the frequency-domain resource mapping relationship based on a position that is of a subcarrier associated with the reference signal and that is in the frequency-domain resource mapping relationship interval for the reference signal.

For example, the transmitter device may perform singular value decomposition on the frequency-domain channel matrix of the antenna port according to the following formula (1), determine the frequency-domain sampling number r and the projection matrix V of the reference signal according to the following formula (2), and then form, according to the following pseudo-code based on the pseudo-random sequence, the matrix P corresponding to the frequency-domain resource mapping relationship. The matrix P may be generated from principal column vectors of the projection matrix.

$${H}_{i} ∈ {ℂ}^{n r x \times n s c} {\to }^{SVD} U \cdot Σ \cdot {V}^{′ H} \qquad Formula ( 1 )$$

Herein, Hᵢ represents a frequency-domain channel matrix of an i^{th} antenna port; nrx represents a number of receive-end antenna ports; nsc represents a number of frequency-domain subcarriers; SVD represents singular value decomposition; U represents a matrix formed by left singular vectors from singular value decomposition; Σ represents a diagonal matrix formed by singular values from singular value decomposition; V′^{H} represents a transpose of V′; and V′ represents a matrix formed by right singular vectors from singular value decomposition.

$$\frac{{\sum }_{k = 1}^{r} {\vert Σ ( k , k ) \vert}^{2}}{{\sum }_{k = 1}^{m i n ( nrx , nsc )} {\vert Σ ( k , k ) \vert}^{2}} \geq T ; {V}^{′} ∈ {ℂ}^{nsc \times m i n ( nr x , n s c )} {\to }^{Truncate} V ∈ {ℂ}^{n s c \times r} \qquad Formula ( 2 )$$

Herein, r represents a frequency-domain sampling number of the reference signal, or r represents a quantity of frequency-domain resources associated with the reference signal; k represents an index of a row element or a column element in the matrix Σ; T represents a transpose of a matrix; and Truncate represents truncation.

### Pseudo-Code:

random_state_configure (random_seed, random_method); #Configure an initial random state by using a random number seed random_seed and a random sequence generation method random_method;
idx=random_permutation(l:nsc, r); # Randomly select r numbers from nsc numbers from 1 to nsc;
P=eye(nsc); # Generate an identity matrix with dimensions of nsc rows and nsc columns;
P=P(:,idx); # Select a column vector specified by idx from a matrix P;
herein, the matrix P is a matrix of nsc*r.

Based on the method shown in FIG. 9, for the transmitter device sending the first information to the receiver device, as shown in FIG. 10, the random number seed may be carried in the first information.

In some embodiments, the first information may further include the frequency-domain sampling number of the reference signal. Alternatively, the frequency-domain sampling number of the reference signal may be indicated by the transmitter device to the receiver device based on other information. This is not limited.

In some embodiments, the first information may further indicate that the frequency-domain resource mapping relationship interval for the reference signal is the third frequency-domain resource mapping relationship interval. Alternatively, in response to the frequency-domain resource mapping relationship interval being the third frequency-domain resource mapping relationship interval, the frequency-domain resource mapping relationship is represented as the random number seed and the frequency-domain sampling number of the reference signal. The frequency-domain resource mapping relationship may indicate a position that is of a subcarrier associated with the reference signal and that is in the third frequency-domain resource mapping relationship interval. In response to the receiver device receiving the first information including the random number seed, the receiver device may determine that the frequency-domain resource mapping relationship interval for the reference signal is the third frequency-domain resource mapping relationship interval.

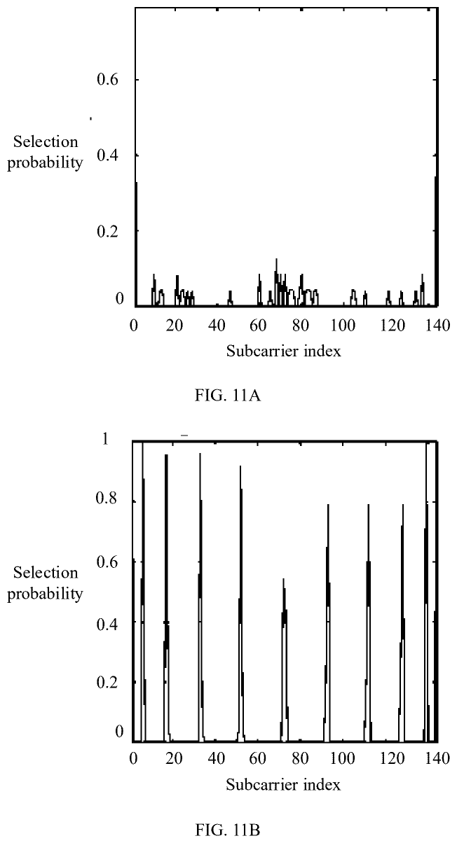

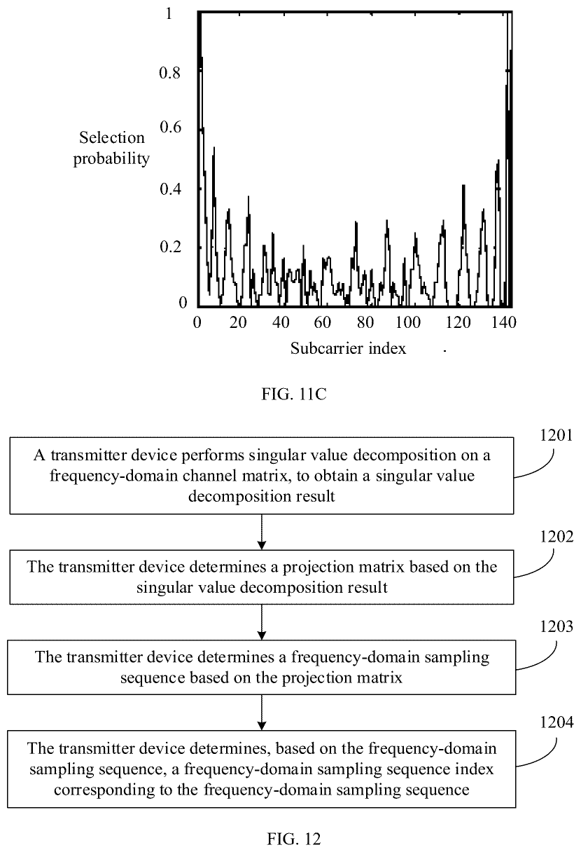

The third frequency-domain resource mapping relationship interval may be a region 3 that has high frequency-domain density (for example, a large frequency-domain sampling number) and that is less sensitive to a resource position for the reference signal, as shown in FIG. 11C. For all frequency-domain resource mapping relationship intervals that have this characteristic (including but not limited to the third frequency-domain resource mapping relationship interval), the random number seed and the frequency-domain sampling number of the reference signal can be used to indicate the frequency-domain resource mapping relationship.

In FIG. 11A to FIG. 11C, three diagrams may be used to respectively indicate probabilities of selecting specific frequency-domain positions for different antenna ports based on frequency-domain resource mapping relationships in three frequency-domain resource mapping relationship intervals. As shown in FIG. 11A, this graph shows probabilities of selecting specific frequency-domain positions for different antenna ports based on a frequency-domain resource mapping relationship in response to the frequency-domain sampling number of the reference signal being equal to three subcarriers. This is a typical case of a frequency-domain resource mapping relationship in a first frequency-domain resource mapping relationship interval. It can be learned from this graph that a probability of selecting a start subcarrier position and a probability of selecting an end subcarrier position are both close to 1, probabilities of selecting other subcarrier positions are small, there are many positions whose selection probabilities are equal to 0, and positions with non-zero selection probabilities exhibit no significant pattern. As shown in FIG. 11B, this graph shows probabilities of selecting specific frequency-domain positions for different antenna ports based on a frequency-domain resource mapping relationship in response to the frequency-domain sampling number of the reference signal being equal to 11 subcarriers. This is a typical case of a frequency-domain resource mapping relationship in a second frequency-domain resource mapping relationship interval. It can be learned from this graph that a probability of selecting a start subcarrier position and a probability of selecting an end subcarrier position are both close to 1, probabilities of selecting specific subcarrier positions are all close to or equal to 1, and positions with non-zero selection probabilities exhibit a significant pattern. As shown in FIG. 11C, this graph shows probabilities of selecting specific frequency-domain positions for different antenna ports based on a frequency-domain resource mapping relationship in response to the frequency-domain sampling number of the reference signal being equal to 19 subcarriers. This is a typical case of a frequency-domain resource mapping relationship in a third frequency-domain resource mapping relationship interval. It can be learned from this graph that a probability of selecting a start subcarrier position and a probability of selecting an end subcarrier position are both close to 1, probabilities of selecting other subcarrier positions are small, there are few positions whose selection probabilities are equal to 0, and positions with non-zero selection probabilities exhibit no significant pattern.

In some embodiments, the transmitter device implicitly indicates, based on the first information, that the frequency-domain resource mapping relationship interval for the reference signal is the third frequency-domain resource mapping relationship interval, different from this, as shown in FIG. 10, the transmitter device may alternatively indicate the frequency-domain resource mapping relationship interval for the reference signal based on the first indication information. This is not limited.

In some embodiments, the first information, the first indication information, and the second indication information may have cycles of different lengths, or may have cycles of a same length. This is not limited.

Based on the foregoing description of the random number seed and the frequency-domain sampling number of the reference signal, the receiver device may determine the frequency-domain resource mapping relationship for the reference signal based on the random number seed and the frequency-domain sampling number of the reference signal according to the method shown in FIG. 9.

For example, the receiver device may determine a pseudo-random sequence based on the random number seed; determine, based on the pseudo-random sequence and the frequency-domain sampling number of the reference signal, a subcarrier associated with each of one or more frequency-domain resources associated with the reference signal; and determine the frequency-domain resource mapping relationship for the reference signal based on a position that is of a subcarrier associated with the reference signal and that is in the third frequency-domain resource mapping relationship interval. Further, as shown in FIG. 10, the receiver device may receive the reference signal from the transmitter device based on the frequency-domain resource mapping relationship for the reference signal, and perform channel estimation based on the reference signal.

In FIG. 9 and FIG. 10, the transmitter device determines and indicates the frequency-domain resource mapping relationship for the reference signal based on the random number seed and the frequency-domain sampling number of the reference signal. Different from this, as shown in FIG. 12 to FIG. 14, the transmitter device may alternatively determine and indicate the frequency-domain resource mapping relationship for the reference signal based on a frequency-domain sampling sequence.

FIG. 12 is a diagram of a method for determining a frequency-domain resource mapping relationship for a reference signal according to an embodiment. As shown in FIG. 12, the method may include the following steps.

Step 1201: The transmitter device performs singular value decomposition on the frequency-domain channel matrix, to obtain a singular value decomposition result.

For example, the transmitter device may perform singular value decomposition on the frequency-domain channel matrix according to formula (1) in FIG. 9, to obtain the singular value decomposition result.

Step 1202: The transmitter device determines a projection matrix based on the singular value decomposition result.

A row number of the projection matrix is equal to a quantity of frequency-domain resources associated with the reference signal, and a column number of the projection matrix is equal to a quantity of frequency-domain subcarriers.

For example, the transmitter device may determine the projection matrix based on the singular value decomposition result according to formula (2) in FIG. 9.

Step 1203: The transmitter device determines a frequency-domain sampling sequence based on the projection matrix.

The frequency-domain resource mapping relationship corresponding to the frequency-domain sampling sequence may be a regular sequence (as shown in FIG. 11B, indexes of frequency-domain positions selected based on the frequency-domain resource mapping relationship are symmetric, and the start frequency-domain position and the end frequency-domain position can be selected with high probabilities), a non-uniform sequence (for example, an interval in the middle is large, and an interval at two ends is small), or a sparse sequence (for example, a sparse matrix, or a corresponding sparse factor or sparse degree being less than or equal to a preset threshold). Alternatively, the frequency-domain sampling sequence may be a low-density sequence distributed at equal intervals.

That the indexes of the frequency-domain positions selected based on the frequency-domain resource mapping relationship are symmetric may mean that a sequence formed by a plurality of indexes of frequency-domain positions selected based on the frequency-domain resource mapping relationship is reversed left and right, and the reversed sequence is added to the original sequence. If a sequence obtained after the addition is a symmetric sequence, it is considered that the indexes of the frequency-domain positions selected based on the frequency-domain resource mapping relationship are symmetric.

For example, as shown in FIG. 11B, a sequence formed by a plurality of indexes of frequency-domain positions selected based on the frequency-domain resource mapping relationship is [1, 6, 17, 33, 52, 72, 93, 112, 128, 139, 144]. The sequence may be reversed left and right, obtaining a reversed sequence [144, 139, 128, 112, 93, 72, 52, 33, 17, 6, 1]. The reversed sequence is added to the original sequence, obtaining a sequence [145, 145, 145, 145, 145, 144, 145, 145, 145, 145, 145], which is a symmetric sequence. This may indicate that the indexes of the frequency-domain positions selected based on the frequency-domain resource mapping relationship are symmetric, as shown in FIG. 11B.

The “selected with high probabilities” may mean that probabilities of selecting, based on the frequency-domain resource mapping relationship, frequency-domain positions with indexes equal to 1 and 144 are close to 1.

For example, according to the following formula (3), the transmitter device may determine, through QR decomposition, a matrix P corresponding to the frequency-domain resource mapping relationship based on the projection matrix, and indicate the matrix P by using a frequency-domain sampling sequence. The matrix P may be generated from principal column vectors of the projection matrix.

$${V}^{H} \cdot {P}^{T} = Q \cdot R \qquad Formula ( 3 )$$

Herein, P^{T} represents a permutation matrix obtained after matrix transposition (where elements are 0 or 1, and a position of 1 represents a frequency-domain position selected based on the frequency-domain resource mapping relationship); Q represents a matrix Q obtained after QR decomposition; and R represents a matrix R obtained after QR decomposition.

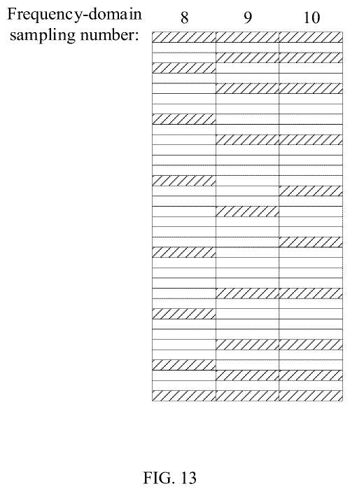

For example, a frequency-domain range of a reference signal is 36 subcarriers. As shown in FIG. 13, three columns from left to right respectively represent a frequency-domain sampling sequence corresponding to a frequency-domain sampling number 8 of the reference signal, a frequency-domain sampling sequence corresponding to a frequency-domain sampling number 9 of the reference signal, and a frequency-domain sampling sequence corresponding to a frequency-domain sampling number 10 of the reference signal.

In some embodiments, a specific value of the frequency-domain sampling sequence may be related to a PRB bundling size and a number of frequency-domain sampling resources for an antenna port. This is not limited.

In some embodiments, a specific value of the frequency-domain sampling sequence is not affected by factors such as a number of multi-user (MU) pairings and a number of antennas of a terminal device.

Step 1204: The transmitter device determines, based on the frequency-domain sampling sequence, a frequency-domain sampling sequence index corresponding to the frequency-domain sampling sequence.

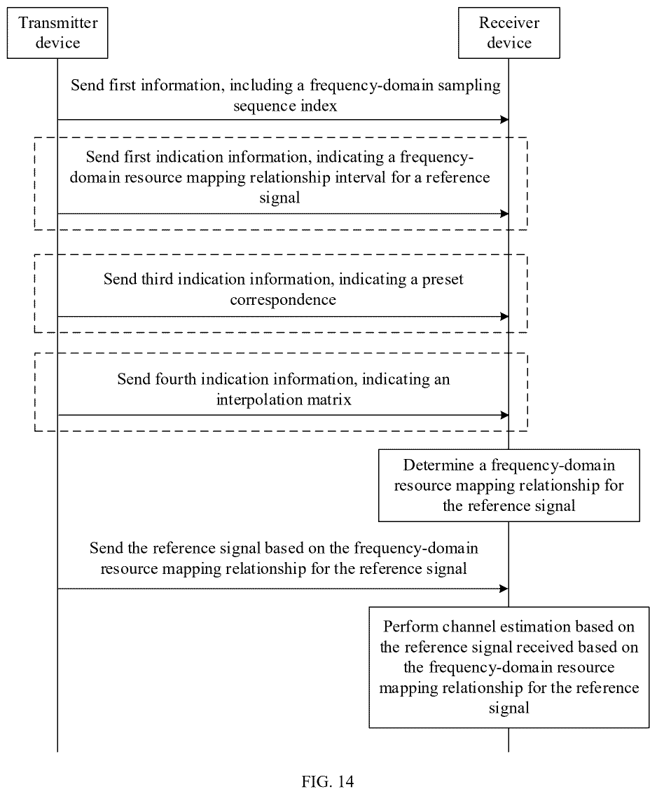

For the transmitter device sending the first information to the receiver device, as shown in FIG. 14, the frequency-domain sampling sequence index may be carried in the first information. The receiver device may determine, from a preset correspondence based on the received first information, the frequency-domain sampling sequence corresponding to the frequency-domain sampling sequence index. Compared with sending the frequency-domain sampling sequence, sending the frequency-domain sampling sequence index can reduce signaling overheads.

The preset correspondence may indicate the frequency-domain sampling sequence index and the frequency-domain sampling sequence corresponding to the frequency-domain sampling sequence index.

For example, the preset correspondence may indicate that a frequency-domain sampling sequence index 00 corresponds to a first frequency-domain sampling sequence, a frequency-domain sampling sequence index 01 corresponds to a second frequency-domain sampling sequence, and a frequency-domain sampling sequence index 10 corresponds to a third frequency-domain sampling sequence.

In some embodiments, the preset correspondence may be predefined in a communication protocol. Alternatively, as shown in FIG. 14, the preset correspondence may be sent by the transmitter device to the receiver device based on third indication information.

In some embodiments, the first information may further indicate that the frequency-domain resource mapping relationship interval for the reference signal is the second frequency-domain resource mapping relationship interval. Alternatively, in response to the frequency-domain resource mapping relationship interval being the second frequency-domain resource mapping relationship interval, the frequency-domain resource mapping relationship is represented as the frequency-domain sampling sequence index. The frequency-domain resource mapping relationship may indicate a position that is of a subcarrier associated with the reference signal and that is in the second frequency-domain resource mapping relationship interval. In response to the receiver device receiving the first information including the frequency-domain sampling sequence index, the receiver device may determine that the frequency-domain resource mapping relationship interval for the reference signal is the second frequency-domain resource mapping relationship interval.

The second frequency-domain resource mapping relationship interval may be a region 2 in which the frequency-domain sampling number is equivalent to the rank of the frequency-domain channel matrix or the first value, as shown in FIG. 11B. For all frequency-domain resource mapping relationship intervals that have this characteristic (including but not limited to the second frequency-domain resource mapping relationship interval), the frequency-domain sampling sequence index can be used to indicate the frequency-domain resource mapping relationship.

In some embodiments, the transmitter device implicitly indicates, based on the first information, that the frequency-domain resource mapping relationship interval for the reference signal is the second frequency-domain resource mapping relationship interval, different from this, as shown in FIG. 14, the transmitter device may alternatively indicate the frequency-domain resource mapping relationship interval for the reference signal based on the first indication information. This is not limited.

In some embodiments, the first information, the first indication information, and the third indication information may have cycles of different lengths, or may have cycles of a same length. This is not limited.

Based on the foregoing description of the frequency-domain sampling sequence index, the receiver device may determine, from a preset correspondence based on the frequency-domain sampling sequence index, a frequency-domain sampling sequence associated with the frequency-domain sampling sequence index; determine, based on the frequency-domain sampling sequence, a subcarrier associated with each of one or more frequency-domain resources associated with the reference signal; and determine the frequency-domain resource mapping relationship based on a position that is of a subcarrier associated with the reference signal and that is in the second frequency-domain resource mapping relationship interval. Further, as shown in FIG. 14, the receiver device may receive the reference signal from the transmitter device based on the frequency-domain resource mapping relationship for the reference signal, and perform channel estimation based on the reference signal.

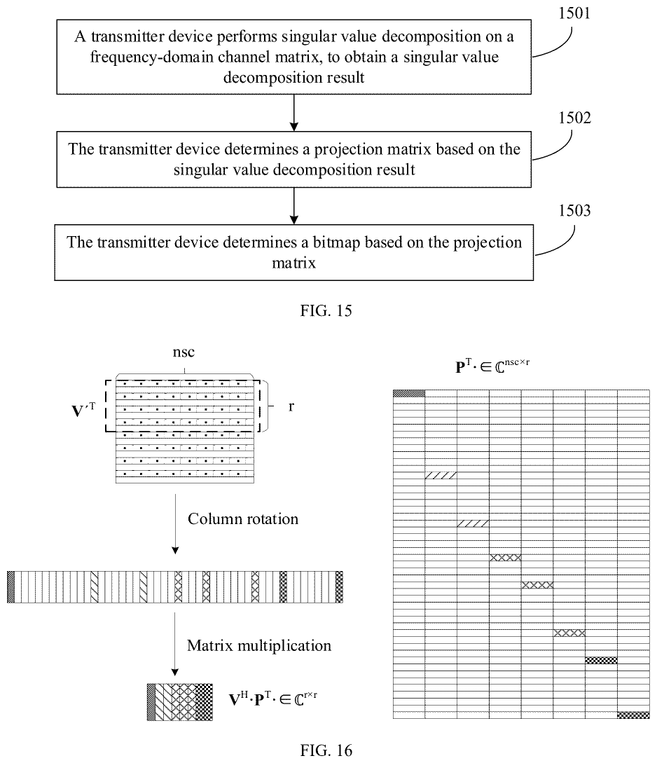

In FIG. 12 to FIG. 14, the transmitter device determines and indicates the frequency-domain resource mapping relationship for the reference signal based on the frequency-domain sampling sequence. Different from this, as shown in FIG. 15 to FIG. 17, the transmitter device may alternatively determine and indicate the frequency-domain resource mapping relationship for the reference signal based on a bitmap.

FIG. 15 is a diagram of a method for determining a frequency-domain resource mapping relationship for a reference signal according to an embodiment. As shown in FIG. 15, the method may include the following steps.

Step 1501: The transmitter device performs singular value decomposition on the frequency-domain channel matrix, to obtain a singular value decomposition result.

Step 1502: The transmitter device determines a projection matrix based on the singular value decomposition result.

A row number of the projection matrix is equal to a quantity of frequency-domain resources associated with the reference signal, and a column number of the projection matrix is equal to a quantity of frequency-domain subcarriers.

For descriptions of step 1501 and step 1502, refer to the foregoing descriptions of step 1201 and step 1202. Details are not described again.

Step 1503: The transmitter device determines a bitmap based on the projection matrix.

The bitmap indicates a subcarrier associated with each of one or more frequency-domain resources associated with the reference signal.

For example, as shown in FIG. 16, a number nsc of frequency-domain subcarriers is 432, and a frequency-domain sampling number r is 8. According to formula (3) V^{H}·P^{T}=Q·R, the transmitter device may determine, through QR decomposition, a matrix P corresponding to the frequency-domain resource mapping relationship based on the projection matrix V, and indicate the matrix P by using a bitmap. The matrix P may be generated from principal column vectors of the projection matrix.

Elements in the matrix P may be 0 or 1, where 0 indicates “unoccupied”, and 1 indicates “occupied”. The bitmap may be represented as r·└log₂ nsc┘.

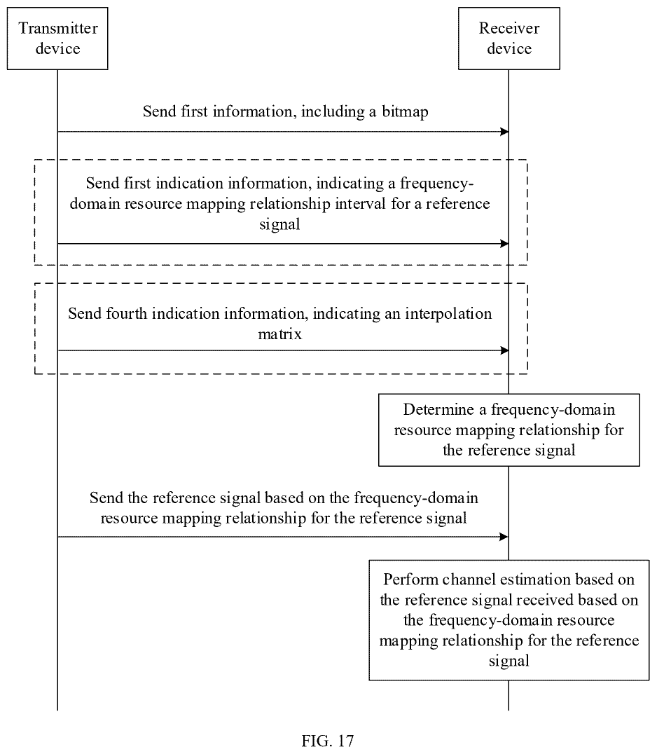

In some embodiments, for the transmitter device sending the first information to the receiver device, as shown in FIG. 17, the bitmap may be carried in the first information. The receiver device may determine the frequency-domain resource mapping relationship based on the bitmap in the received first information.

In some embodiments, the first information may further indicate that the frequency-domain resource mapping relationship interval for the reference signal is the first frequency-domain resource mapping relationship interval. Alternatively, in response to the frequency-domain resource mapping relationship interval being the first frequency-domain resource mapping relationship interval, the frequency-domain resource mapping relationship is represented as the bitmap. The frequency-domain resource mapping relationship may indicate a position that is of a subcarrier associated with the reference signal and that is in the first frequency-domain resource mapping relationship interval. In response to the receiver device receiving the first information including the bitmap, the receiver device may determine that the frequency-domain resource mapping relationship interval for the reference signal is the first frequency-domain resource mapping relationship interval.

The first frequency-domain resource mapping relationship interval may be a region 1 that has extremely low frequency-domain density and that is very sensitive to a resource position for the reference signal, as shown in FIG. 11A. For all frequency-domain resource mapping relationship intervals that have this characteristic (including but not limited to the first frequency-domain resource mapping relationship interval), the bitmap can be used to indicate the frequency-domain resource mapping relationship.

In some embodiments, the transmitter device implicitly indicates, based on the first information, that the frequency-domain resource mapping relationship interval for the reference signal is the first frequency-domain resource mapping relationship interval, different from this, as shown in FIG. 17, the transmitter device may alternatively indicate the frequency-domain resource mapping relationship interval for the reference signal based on the first indication information. This is not limited.

In some embodiments, the first information and the first indication information may have cycles of different lengths, or may have cycles of a same length. This is not limited.

In some embodiments, based on the foregoing descriptions of FIG. 5 to FIG. 17, the transmitter device may further send fourth indication information to the receiver device. For example, as shown in FIG. 10, FIG. 14, or FIG. 17, the transmitter device may send the fourth indication information to the receiver device.

The fourth indication information indicates an interpolation matrix, and the interpolation matrix is used to assist the receiver device in channel estimation, to improve system spectral efficiency.

For example, the transmitter device may determine the interpolation matrix p^{†} based on the matrix P corresponding to the frequency-domain resource mapping relationship according to the following formula: P^{†}=(V^{H}·P^{T})⁻¹·V^{H} ∈ [symbol] ^{r×nsc}.

In some embodiments, the transmitter device may quantize the interpolation matrix, include a quantization result in the fourth indication information, and send the fourth indication information to the receiver device, to reduce signaling overheads.

In some embodiments, the first information, the first indication information, the second indication information, the third indication information, and the fourth indication information may have cycles of different lengths, or may have cycles of a same length. This is not limited.

It should be noted that various embodiments may be implemented separately, or may be implemented in combination. This is not limited. Unless otherwise stated or there is a logic conflict, terms and/or descriptions in different embodiments provided in this disclosure are consistent and may be mutually referenced, and technical features in different embodiments may be combined based on an internal logical relationship thereof, to form a new embodiment.

It may be understood that, in embodiments of this disclosure, an execution body may perform some or all of steps in embodiments of this disclosure. These steps or operations are merely examples. Other operations or variants of various operations may be further performed in embodiments of this disclosure. In addition, the steps may be performed in a sequence different from a sequence presented in embodiments of this disclosure, and not all operations in embodiments of this disclosure need to be performed.

The solutions provided in embodiments of this disclosure are mainly described above from a perspective of interaction between the devices. It may be understood that, to implement the foregoing functions, each device includes a corresponding hardware structure and/or a corresponding software module for performing each function. A person skilled in the art should easily be aware that, in combination with algorithms and steps in the examples described in embodiments disclosed in this specification, this disclosure can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this disclosure.

In embodiments of this disclosure, each device may be divided into functional modules based on the foregoing method examples. For example, each functional module may be obtained through division based on each corresponding function, or two or more functions may be integrated into one processing module. The integrated module may be implemented in a form of hardware, or may be implemented in a form of a software functional module. It should be noted that, in embodiments of this disclosure, division into the modules is an example and is merely logical function division, and may be other division during actual implementation.

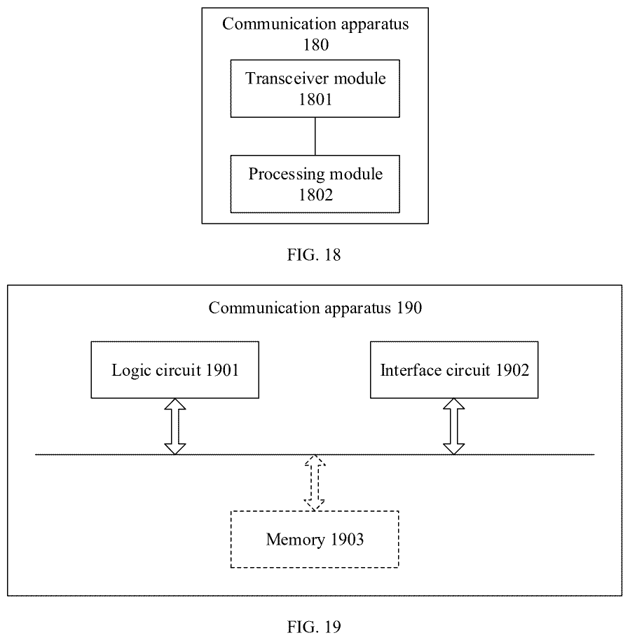

When each functional module is obtained through division based on each corresponding function, FIG. 18 shows a communication apparatus 180. The communication apparatus 180 may perform actions performed by the transmitter device or the receiver device in the methods shown in FIG. 5 to FIG. 17. All related content of steps in the foregoing method embodiments may be referenced in functional descriptions of corresponding functional modules. For technical effects that can be achieved by the communication apparatus 180, refer to the foregoing method embodiments. Details are not described herein again.

The communication apparatus 180 may include a transceiver module 1801 and a processing module 1802. For example, the communication apparatus 180 may be a communication device, or may be a chip used in a communication device, or another combined device or component with functions of the communication apparatus. When the communication apparatus 180 is a communication device, the transceiver module 1801 may be a transceiver, where the transceiver may include an antenna, a radio frequency circuit, and the like; and the processing module 1802 may be a processor (or a processing circuit), for example, a baseband processor, where the baseband processor may include one or more CPUs. When the communication apparatus 180 is a component with functions of the communication apparatus, the transceiver module 1801 may be a radio frequency unit; and the processing module 1802 may be a processor (or a processing circuit), for example, a baseband processor. When the communication apparatus 180 is a chip system, the transceiver module 1801 may be an input/output interface of a chip (for example, a baseband chip); and the processing module 1802 may be a processor (or a processing circuit) of the chip system, and may include one or more central processing units. It should be understood that, in embodiments of this disclosure, the transceiver module 1801 may be implemented by a transceiver or a transceiver-related circuit component; and the processing module 1802 may be implemented by a processor or a processor-related circuit component (or referred to as a processing circuit).

For example, the transceiver module 1801 may be configured to perform all sending and receiving operations performed by the communication apparatus in the embodiments shown in FIG. 5 to FIG. 17, and/or configured to support another process of the technology described in this specification; and the processing module 1802 may be configured to perform all operations performed by the communication apparatus in the embodiments shown in FIG. 5 to FIG. 17 except the sending and receiving operations, and/or configured to support another process of the technology described in this specification.

In some embodiments, in FIG. 18, the transceiver module 1801 may be replaced with a transceiver, and a function of the transceiver module 1801 may be integrated into the transceiver; and the processing module 1802 may be replaced with a processor, and a function of the processing module 1802 may be integrated into the processor. Further, the communication apparatus 180 shown in FIG. 18 may further include a memory.

Alternatively, when the processing module 1802 is replaced with a processor, and the transceiver module 1801 is replaced with a transceiver, the communication apparatus 180 in embodiments of this disclosure may be a communication apparatus 190 shown in FIG. 19. The processor may be a logic circuit 1901, and the transceiver may be an interface circuit 1902. Further, the communication apparatus 190 shown in FIG. 19 may further include a memory 1903.

An embodiment further provides a computer program product. When the computer program product is executed by a computer, a function of any one of the foregoing method embodiments may be implemented.

An embodiment further provides a computer program. When the computer program is executed by a computer, a function of any one of the foregoing method embodiments may be implemented.

An embodiment further provides a computer-readable storage medium. All or some of procedures in the foregoing method embodiments may be implemented by a computer program instructing related hardware. The program may be stored in the computer-readable storage medium. When the program is executed, the procedures in the foregoing method embodiments may be performed. The computer-readable storage medium may be an internal storage unit in a terminal (including a data transmit end and/or a data receive end) in any one of the foregoing embodiments, for example, a hard disk or an internal memory of the terminal. The computer-readable storage medium may alternatively be an external storage device of the terminal, for example, a plug-in hard disk, a smart media card (SMC), a secure digital (SD) card, or a flash card that is configured on the terminal. Further, the computer-readable storage medium may further include both an internal storage unit and an external storage device of the terminal. The computer-readable storage medium is configured to store the computer program and other programs and data for the terminal. The computer-readable storage medium may be further configured to temporarily store data that has been output or that is to be output.

It should be noted that, in the specification, claims, and accompanying drawings, the terms “first”, “second”, and the like are intended to distinguish between different objects but do not indicate a particular sequence. “First” and “second” are merely intended for a purpose of description, and shall not be understood as an indication or implication of relative importance or implicit indication of a quantity of indicated technical features. Therefore, a feature limited by “first” or “second” may explicitly or implicitly include one or more features. In the description of embodiments, unless otherwise specified, “a plurality of” means two or more.

In addition, the terms “include”, “have”, and any variants thereof are intended to cover a non-exclusive inclusion. For example, a process, method, system, product, or device including a series of steps or units is not limited to the listed steps or units, but further optionally includes steps or units that are not listed, or further optionally includes other steps or units inherent to the process, method, product, or device.

It should be understood that, in this disclosure, “at least one (item)” means one or more. “A plurality of” means two or more than two. “At least two (items)” means two, three, or more than three. “And/or” is used to describe an association relationship between associated objects, and indicates that three relationships may exist. For example, “A and/or B” may indicate the following three cases: Only A exists, only B exists, and both A and B exist, where A and B may be singular or plural. The character “/” usually indicates an “or” relationship between the associated objects. “At least one of the following items (pieces)” or a similar expression thereof means any combination of these items, including a singular item (piece) or any combination of plural items (pieces). For example, at least one of a, b, or c may indicate a, b, c, a and b, a and c, b and c, or a, b, and c, where a, b, and c may be singular or plural. Both “when . . . ” and “if” mean that corresponding processing is performed in an objective case, are not intended to limit time, do not require a determining action during implementation, and do not mean that there is another limitation.

In embodiments of this disclosure, the word such as “example” or “for example” is intended to indicate giving an example, an illustration, or a description. Any embodiment or design scheme described as an “example” or “for example” in embodiments of this disclosure should not be explained as being more preferred or having more advantages than another embodiment or design scheme. Use of the word such as “example” or “for example” is intended to present a related concept in a described manner for ease of understanding.

In this disclosure, “sending information to . . . (a terminal device)” may be understood as that a destination of the information is the terminal device, and may include directly or indirectly sending the information to the terminal device. “Receiving information from . . . (a terminal device)” may be understood as that a source of the information is the terminal device, and may include directly or indirectly receiving the information from the terminal device. The information may undergo processing, for example, a format change, between the source for sending the information and the destination. However, the destination may understand valid information from the source.

The foregoing descriptions of embodiments allow a person skilled in the art to understand that, for the purpose of convenient and brief description, division into the foregoing functional modules is merely used as an example for illustration. During actual application, the foregoing functions may be allocated to different functional modules for implementation. In other words, an internal structure of the apparatus is divided into different functional modules to implement all or some of the functions described above.

In the several embodiments, it should be understood that the disclosed apparatus and method may be implemented in other manners. For example, the described apparatus embodiments are merely examples. For example, division into the modules or units is merely logical function division and may be other division during actual implementation. For example, a plurality of units or components may be combined or integrated into another apparatus, or some features may be omitted or not be performed. In addition, the displayed or discussed mutual couplings or direct couplings or communication connections may be implemented through some interfaces. The indirect couplings or communication connections between the apparatuses or units may be implemented in an electrical form, a mechanical form, or another form.

The units described as separate parts may or may not be physically separate, and parts displayed as units may be one or more physical units, for example, may be located in one place, or may be distributed in different places. Some or all of the units may be selected based on actual criteria to achieve the objectives of the solutions of embodiments.

In addition, functional units in embodiments of this disclosure may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a readable storage medium. Based on such an understanding, the technical solutions of embodiments of this disclosure essentially or all or some of the technical solutions may be implemented in the form of a software product. The software product is stored in a storage medium and includes several instructions for enabling a device (which may be a single-chip microcomputer, a chip, or the like) or a processor to perform all or some of the steps of the methods described in embodiments of this disclosure. The foregoing storage medium includes any medium that can store program code, such as a USB flash drive, a removable hard disk, a ROM, a RAM, a magnetic disk, or an optical disc.

What claimed is:

1. A reference signal transmission method, comprising:
determining, based on a frequency-domain channel matrix associated with an antenna port and a frequency-domain sampling number of a reference signal associated with the antenna port, a frequency-domain resource mapping relationship for the reference signal;
sending first information to a receiver device, wherein the first information indicates the frequency-domain resource mapping relationship for the reference signal; and
sending or receiving the reference signal based on the frequency-domain resource mapping relationship for the reference signal.

2. The method according to claim 1, wherein the determining, based on the frequency-domain channel matrix associated with the antenna port and the frequency-domain sampling number of the reference signal associated with the antenna port, the frequency-domain resource mapping relationship for the reference signal comprises:
determining a frequency-domain resource mapping relationship interval for the reference signal based on the frequency-domain channel matrix and the frequency-domain sampling number of the reference signal; and
determining the frequency-domain resource mapping relationship for the reference signal based on the frequency-domain resource mapping relationship interval for the reference signal and the frequency-domain sampling number of the reference signal.

3. The method according to claim 2, wherein the determining the frequency-domain resource mapping relationship interval for the reference signal based on the frequency-domain channel matrix and the frequency-domain sampling number of the reference signal comprises:
determining a rank of the frequency-domain channel matrix and a first value based on the frequency-domain channel matrix, wherein the first value is a quantity of singular values that meet a first condition and that are in a singular value decomposition result of the frequency-domain channel matrix, and the first condition is that a difference between a reconstructed matrix corresponding to a singular value and the frequency-domain channel matrix is less than or equal to a first threshold; and
determining the frequency-domain resource mapping relationship interval for the reference signal based on the rank of the frequency-domain channel matrix, the first value, and the frequency-domain sampling number of the reference signal.

4. The method according to claim 3, wherein
when the frequency-domain sampling number of the reference signal is less than or equal to the first value, the frequency-domain resource mapping relationship interval for the reference signal is a first frequency-domain resource mapping relationship interval; or
when the frequency-domain sampling number of the reference signal is greater than the first value and is less than or equal to the rank of the frequency-domain channel matrix, the frequency-domain resource mapping relationship interval for the reference signal is a second frequency-domain resource mapping relationship interval; or
when the frequency-domain sampling number of the reference signal is greater than the rank of the frequency-domain channel matrix, the frequency-domain resource mapping relationship interval for the reference signal is a third frequency-domain resource mapping relationship interval.

5. The method according to claim 2, wherein the method further comprises:
sending first indication information to the receiver device, wherein the first indication information indicates the frequency-domain resource mapping relationship interval for the reference signal.

6. The method according to claim 5, wherein
the first indication information comprises the rank of the frequency-domain channel matrix, the first value, and the frequency-domain sampling number of the reference signal, wherein the first value is a quantity of singular values that meet the first condition and that are in a singular value decomposition result of the frequency-domain channel matrix, and the first condition is that a difference between a reconstructed matrix corresponding to a singular value and the frequency-domain channel matrix is less than or equal to the first threshold; or
the first indication information comprises an interval index of the frequency-domain resource mapping relationship interval for the reference signal; or
the first indication information comprises interval frequency-domain range information of the frequency-domain resource mapping relationship interval for the reference signal; or
the first indication information comprises interval position information of the frequency-domain resource mapping relationship interval for the reference signal.

7. A reference signal transmission method, comprising:
obtaining first information, wherein the first information indicates a frequency-domain resource mapping relationship for a reference signal associated with an antenna port; and
receiving or sending the reference signal based on the frequency-domain resource mapping relationship for the reference signal.

8. The method according to claim 7, wherein
the first information comprises a random number seed.

9. The method according to claim 8, wherein
the first information further comprises a frequency-domain sampling number of the reference signal.

10. The method according to claim 8, wherein
the first information further indicates that a frequency-domain resource mapping relationship interval for the reference signal is a third frequency-domain resource mapping relationship interval.

11. The method according to claim 8, comprising:
determining a pseudo-random sequence based on the random number seed;
determining, based on the pseudo-random sequence and the frequency-domain sampling number of the reference signal, a subcarrier associated with each of one or more frequency-domain resources associated with the reference signal; and
determining the frequency-domain resource mapping relationship based on a position that is of a subcarrier associated with the reference signal and that is in the third frequency-domain resource mapping relationship interval.

12. The method according to claim 7, wherein
the first information comprises a frequency-domain sampling sequence index.

13. The method according to claim 12, wherein
the first information further indicates that a frequency-domain resource mapping relationship interval for the reference signal is a second frequency-domain resource mapping relationship interval.

14. A communication apparatus, wherein the communication apparatus comprises at least one processor, and one or more memories coupled to the at least one processor and storing programming instructions for execution by the at least one processor, to enable the communication apparatus to:
obtain first information, wherein the first information indicates a frequency-domain resource mapping relationship for a reference signal associated with an antenna port; and
receive or send the reference signal based on the frequency-domain resource mapping relationship for the reference signal.

15. The communication apparatus according to claim 14, wherein
the first information comprises a random number seed.

16. The communication apparatus according to claim 15, wherein
the first information further comprises a frequency-domain sampling number of the reference signal.

17. The communication apparatus according to claim 15, wherein
the first information further indicates that a frequency-domain resource mapping relationship interval for the reference signal is a third frequency-domain resource mapping relationship interval.

18. The communication apparatus according to claim 15, wherein the communication apparatus is to:
determine a pseudo-random sequence based on the random number seed;
determine, based on the pseudo-random sequence and the frequency-domain sampling number of the reference signal, a subcarrier associated with each of one or more frequency-domain resources associated with the reference signal; and
determine the frequency-domain resource mapping relationship based on a position that is of a subcarrier associated with the reference signal and that is in the third frequency-domain resource mapping relationship interval.

19. The communication apparatus according to claim 14, wherein
the first information comprises a frequency-domain sampling sequence index.

20. The communication apparatus according to claim 19, wherein
the first information further indicates that a frequency-domain resource mapping relationship interval for the reference signal is a second frequency-domain resource mapping relationship interval.
